(19) United States
(12) Patent Application Publication
(10) Pub. No.: US 2002/0098973 A1
(43) Pub. Date: Jul. 25, 2002

(54) Bridged gallium or indium containing group 4 metal complexes

(76) Inventors: Richard E. Campbell JR., Midland, MI (US); David D. Devore, Midland, MI (US); Shaoguang Feng, Midland, MI (US); Kevin A. Frazier, Midland, MI (US); D. Patrick Green, Midland, MI (US); Jasson T. Patton, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/727,997

(22) Filed: Dec. 1, 2000

Related U.S. Application Data
(60) Provisional application No. 60/172,951, filed on Dec. 21, 1999.

(51) Int. Cl. C08F 4/44

(52) U.S. Cl. 502/155; 526/901; 526/160; 526/170; 526/943; 526/127

(57) ABSTRACT

A Group 4 transition metal complex containing a gallium or indium bridging group containing an electron donating group, especially an amido group, linking two groups which may be π-bonding groups or electron donating groups.

### CROSS REFERENCE STATEMENT

This application claims the benefit of U.S. Provisional Application No. 60/172,951, filed Dec. 21, 1999.

### BACKGROUND OF THE INVENTION

This invention relates to certain bridged Group 4 transition metal complexes possessing a unique bridging structure and to olefin polymerization catalysts obtained from such complexes. In one form, this invention embodies Group 4 transition metal complexes containing a unique bridged, or divalent ligand structure having two anionic, delocalized π-bonded ligands that are joined by a gallium or indium containing grouping. In a second embodiment the invention relates to Group 4 transition metal complexes containing a unique bridged ligand containing one of the foregoing anionic, delocalized π-bonded moieties and one anionic amido or phosphido moiety, or a donor electron pair containing amino or phosphino moiety, which two moieties are similarly joined by a gallium or indium containing grouping. In a third embodiment the invention relates to Group 4 transition metal complexes containing a unique bridged ligand containing two anionic amido and/or phosphido groups joined by a gallium or indium containing grouping. Catalyst compositions comprising the foregoing metal complexes and their use in addition polymerizations are also disclosed and claimed.

In Angew. Chem. Int. Ed. Engl., 36, 21, p2338-2340 (1997) and in Phosphorus, Sulfur, and Silicon, 124 & 125, p561-565 (1997) amido substituted boron bridged ferrocenophanes useful for forming poly(ferrocenes) by a ring opening polymerization were disclosed. The synthesis and characterization of Group 1 and 2 metal and tin complexes of 1,2-bis(dimethylamino)-1,2-di-9-fluorenyldiboranes were disclosed in Chem. Ber., 127, p1901-1908, (1994). Diboranes having structure similar to those employed in the foregoing study were disclosed by the same researchers in Eur. J. Inorg. Chem., p505-509 (1998). Ferrocenophane derivatives of similar bisboranes for further molecular property studies were disclosed by J. Organomet. Chem., 530 p 117-120 (1997). In Organometallics, 16, p4546-4550 (1997) boron bridged ansa metallocene complexes including dimethylsulfide and phosphine adducts thereof of possible use in Ziegler-Natta-type olefin polymerizations were disclosed.

In the patent literature, bridged metal complexes for use as olefin polymerization catalyst components, including such complexes containing one or more boron atoms in the bridge are generically disclosed by EP-A-416,815 and WO 98/39369. Generally, gallium or indium containing groups are unknown in metal complexes of the prior art.

### SUMMARY OF THE INVENTION

The present invention relates to certain bridged Group 4 transition metal complexes and to olefin polymerization catalysts obtained there from, said complexes corresponding to the following formula:

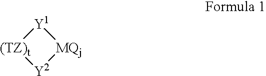

wherein:

M is titanium, zirconium, or hafnium in the +4,+3, or +2 oxidation state;

Y¹ and Y² are independently an anionic or neutral, cyclic or non-cyclic, π-bonded group, NR¹, PR¹; NR¹₂, PR¹, or (R**)₃—P═N—;

R** is in one occurrence a covalent bond to Z and in all remaining occurrences a monovalent ligand, illustrated by hydrogen, halogen, or C₁₋₁₀ hydrocarbyl, or two R** groups together form a divalent ligand,

Z is gallium or indium;

Q is a neutral, anionic or dianionic ligand group depending on the oxidation state of M;

j is 1 or 2 depending on the oxidation state of M and the electronic nature of Q;

t is 1 or 2, and when t is 2 there is a direct Z—Z bond;

T independently each occurrence is: —OR¹, —SR¹, —NR¹₂, —PR¹₂, —N═CR¹₂, —N═PR¹₃,

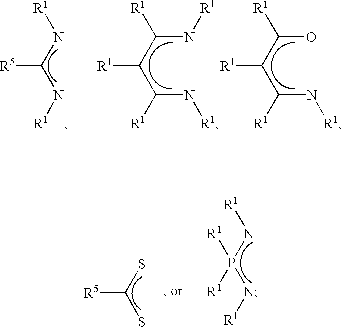

R¹ is independently each occurrence hydrogen, a hydrocarbyl group, a tri(hydrocarbyl)silyl group, or a tri(hydrocarbyl)silylhydrocarbyl group, said R¹ groups containing up to 20 atoms not counting hydrogen;

R⁵ is R¹ or —N(R¹)₂; and

two R¹ groups together or one or more R¹ groups together with R⁵ may optionally be joined to form a ring structure.

It is understood that the foregoing metal complexes may exist as dimers and that one or more Lewis bases may optionally be coordinated with the complex or the dimer thereof and that when Y¹ or Y² are the neutral ligands, NR¹₂ or PR¹₂, the bond to M is a coordinate-covalent bond rather than a covalent bond, and j=2. In addition, when T is R¹₂N, the bond between T and Z, particularly in the compounds of formula 1, may possess double bond characteristics, that is, the resulting group may more accurately depicted by the formula R¹₂N═Ga or R¹₂N═In.

Additionally, according to the present invention there are provided unique ligand structures of the following formula 1A:

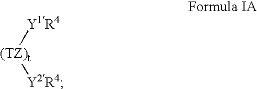

wherein Z, T, t, R¹ and R⁵ are as defined above;

Y^{1′} and Y^{2′} are anionic, cyclic or non-cyclic, π-bonded groups, NR¹, or PR¹; and

R⁴ is hydrogen, a trimethylsilyl group or a trimethyl tin group.

Such ligand groups of Formula 1A are readily prepared by contacting sources of the anionic groups (Y^{1′}R⁴)⁻ and (Y^{2′}R⁴)⁻, particularly the Grignard or alkali metal salts thereof, with the neutral compound TZY³ or (TZ)₂Y³₂, where Y³ is a leaving group, especially halide, either as neat reagents or in an inert solvent, employing temperatures from −100° C. to 150° C.

Additionally, according to the present invention there is provided a process for preparing complexes of formula 1 in high racemic purity in the +2 formal oxidation state by contacting ligand structures of formula 1A where R⁴ is trimethylsilyl, or deprotonated dianionic derivatives of ligand structures of formula 1A with a Group 4 precursor of the formula 3:

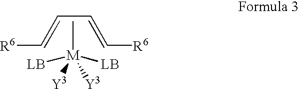

wherein M and Y³ are defined as above,

R⁶ independently each occurrence is hydrogen, a hydrocarbyl group, a tri(hydrocarbyl)silyl group, or a tri(hydrocarbyl)silylhydrocarbyl group, said R⁶ groups containing up to 20 atoms not counting hydrogen; and

LB is a Lewis base, especially an ether, amine, or phosphine of up to 20 carbons.

The reaction is desirably conducted in an inert solvent, especially an aliphatic or aromatic hydrocarbon or ether, employing temperatures from −100° C. to 150° C. This technique is similar to that disclosed in U.S. patent application 265,641, filed Mar. 10, 1999, differing in that different starting reagents are employed.

Further according to the present invention there are provided catalyst compositions suitable for the polymerization of addition polymerizable monomers comprising one or more metal complexes of formula 1 in combination with one or more activating cocatalysts or activated by use of an activating technique.

Finally, according to the present invention there is also provided a polymerization process comprising contacting one or more addition polymerizable monomers with a catalyst composition comprising one or more metal complexes of formula 1 in combination with one or more activating cocatalysts or activated by use of an activating technique. The polymerization is preferably performed under solution, slurry, suspension, or high pressure process conditions, and the catalyst composition or individual components thereof may be used in a heterogeneous state, that is, supported on an inert support, or in a homogeneous state as dictated by process conditions. The catalysts of the present invention can be used in combination with one or more additional catalysts of the same or different nature either simultaneously or sequentially in the same or in separate reactors.

Catalyst compositions according to the present invention possess improved catalytic efficiencies and improved thermal stability, especially when supported on an inert support, allowing for use under higher operating temperatures compared to catalysts comprising conventional metal complexes. They are particularly adapted for use under stereospecific polymerization conditions to provide highly tactic (isotactic or syndiotactic) polyolefin products.

### BRIEF DESCRIPTION OF THE DRAWINGS

FIG. 1 shows the single crystal structure derived by X-ray analysis (ORTEP) of Bis(dimethylamido)bis(2,6-diisopropylanilide)-indium-t-butyl-N,N′-diisopropylamidinate-titanium (Example 1).

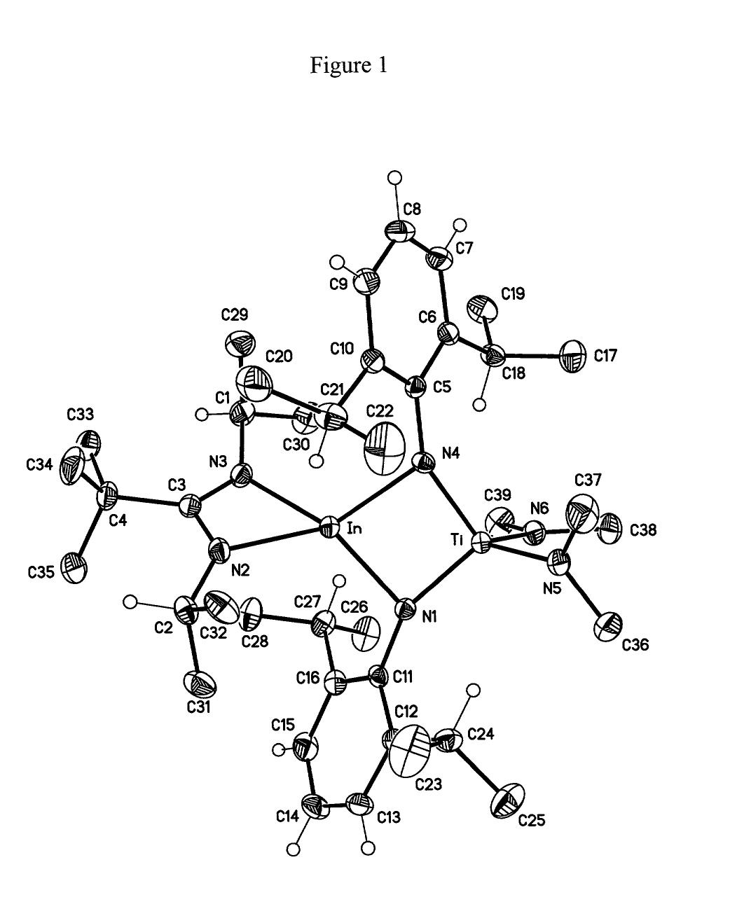

### DETAILED DESCRIPTION

All references to the Periodic Table of the Elements herein shall refer to the Periodic Table of the Elements, published and copyrighted by CRC Press, Inc., 1999. Also, any references to a Group or Groups shall be to the Groups or Groups reflected in this Periodic Table of the Elements using the IUPAC system for numbering groups. Where any name of a chemical supplied herein does not correspond to a formula or structure of such chemical, the formula or structure shall control. For purposes of prosecution in the United States of America, where any reference is made herein to any publication, patent application or provisional patent application, the contents thereof are incorporated herein in their entirety by reference. By the term “π-bonded” as used herein is meant that bonding occurs through an interaction involving delocalized electrons. As used herein the term “comprising” is not intended to exclude any additional component, additive or step. Finally, by the term, “leaving group” is meant a ligand that is readily displaced by another ligand under ligand exchange conditions.

The present Group 4 transition metal complexes contain a unique bridging group: (T-Z) or (T-Z)₂, which imparts improved catalytic properties when used in combination with one or more activating cocatalysts or activating techniques in the presence of addition polymerizable monomers. While not desiring to be bound by theory, it is believed that the improvement in catalytic properties for such complexes may be due to the electronic properties of the (TZ)ₜ, Y¹ and Y² moieties.

Suitable Y¹ and Y² groups are π-bonded anionic or neutral ligand groups, which may be cyclic or non-cyclic delocalized π-bonded anionic ligand groups. Exemplary of such π-bonded groups are conjugated or nonconjugated, cyclic or non-cyclic dienyl groups, allyl groups, boratabenzene groups, phosphole, and arene groups. Each atom in the delocalized π-bonded group may independently be substituted with a radical selected from the group consisting of hydrogen, halogen, hydrocarbyl, halohydrocarbyl, hydrocarbyl-substituted metalloid radicals wherein the metalloid is selected from Group 14 of the Periodic Table of the Elements, and such hydrocarbyl- or hydrocarbyl-substituted metalloid radicals further substituted with a Group 15 or 16 hetero atom containing moiety. Included within the term “hydrocarbyl” are C₁₋₂₀ straight, branched and cyclic alkyl radicals, C₆₋₂₀ aromatic radicals, C₇₋₂₀ alkyl-substituted aromatic radicals, and C₇₋₂₀ aryl-substituted alkyl radicals. In addition two or more such radicals may together form a fused ring system, including partially or fully hydrogenated fused ring systems, or they may form a metallocycle with the metal. Suitable hydrocarbyl-substituted organometalloid radicals include mono-, di- and tri-substituted organometalloid radicals of Group 14 elements wherein each of the hydrocarbyl groups contains from 1 to 20 carbon atoms. Examples of suitable hydrocarbyl-substituted organometalloid radicals include trimethylsilyl, triethylsilyl, ethyldimethylsilyl, methyldiethyl-silyl, triphenylgermyl, and trimethylgermyl groups. Examples of Group 15 or 16 hetero atom containing moieties include amine, phosphine, ether or thioether moieties or divalent derivatives thereof, e.g. amide, phosphide, ether or thioether groups bonded to the transition metal or Lanthanide metal, and bonded to the hydrocarbyl group or to the hydrocarbyl-substituted metalloid containing group.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl groups, phosphole, and boratabenzene groups, as well as hydrocarbyl-silyl- (including mono-, di-, or tri(hydrocarbyl)silyl) substituted derivatives thereof. Preferred anionic, delocalized π-bonded groups are cyclopentadienyl, pentamethylcyclopentadienyl, tetramethylcyclopentadienyl, tetramethyl(trimethylsilyl)cyclopentadienyl, inden-1-yl, 2,3-dimethylinden-1-yl, fluorenyl, 2-methylinden-1-yl, 2-methyl-4-phenylinden-1-yl, 3-(1-pyrrolidinyl)inden-1-yl, tetrahydrofluorenyl, octahydrofluorenyl, and tetrahydroindenyl.

Boratabenzene groups are anionic ligands that are charged boron containing analogues to benzene. They are previously known in the art having been described by G. Herberich, et al., in Organometallics, 14,1, 471-480 (1995). Preferred boratabenzene ligands correspond to the formula:

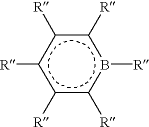

wherein R″ is selected from the group consisting of hydrocarbyl, silyl, N,N-dihydrocarbylamino, or germyl, said R″ having up to 20 non-hydrogen atoms. In complexes involving divalent derivatives of such delocalized π-bonded groups one atom thereof is bonded by means of a covalent bond or a covalently bonded divalent group to another atom of the complex thereby forming a bridged system.

Phospholes are anionic ligands that are phosphorus containing analogues to a cyclopentadienyl group. They are previously known in the art having been described by WO 98/50392, and elsewhere. Preferred phosphole ligands correspond to the formula:

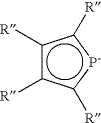

wherein R″ is selected from the group consisting of hydrocarbyl, silyl, N,N-dihydrocarbylamino, or germyl, said R″ having up to 20 non-hydrogen atoms, and optionally one or more R″ groups may be bonded together forming a multicyclic fused ring system, or form a bridging group connected to the metal. In complexes involving divalent derivatives of such delocalized π-bonded groups one atom thereof is bonded by means of a covalent bond or a covalently bonded divalent group to another atom of the complex thereby forming a bridged system.

Phosphinimine containing complexes (i.e., wherein Y¹ or Y² is (R**)₃—P═N—) are known in the art, having been previously disclosed in EP-A-890581.

Preferred Group 4 transition metal complexes of the present invention which correspond to formula 1 are represented in formulas 4, 5, 6, and 7:

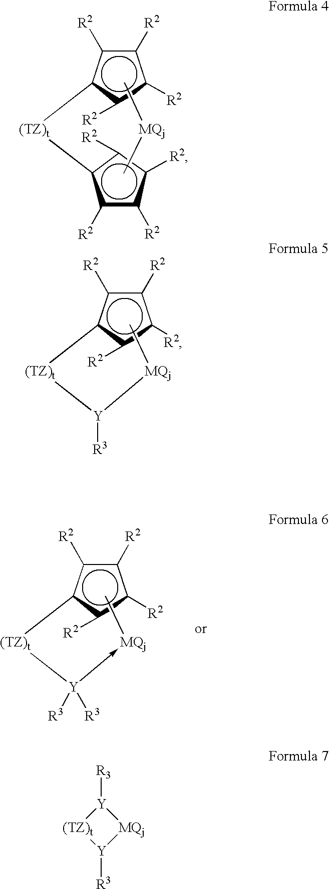

wherein M, Z, T, Q, t and j are as defined above with respect to formula 1;

R² is hydrogen, or a hydrocarbyl, halohydrocarbyl, dihydrocarbylamino-hydrocarbyl, tri(hydrocarbylsilyl)hydrocarbyl, Si(R³)₃, N(R³)₂, or OR³ group of up to 20 carbon or silicon atoms, and optionally two adjacent R² groups can be joined together, thereby forming a fused ring structure, especially an indenyl ligand or a substituted indenyl ligand;

R³ is independently hydrogen, a hydrocarbyl group, a trihydrocarbylsilyl group or a trihydrocarbylsilylhydrocarbyl group, said R³ having up to 20 atoms not counting hydrogen; and

Y is nitrogen or phosphorous.

When M is in the +4 oxidation state, in formula 4, j=2 and Q independently each occurrence is halide, hydride, hydrocarbyl, trihydrocarbylsilylhydrocarbyl, hydrocarbyloxide, dihydrocarbylamide, said Q having up to 20 atoms not counting hydrogen. Alternatively, two Q groups may be joined together to form an alkanediyl- or silylenebisalkylene-group or a conjugated C₄₋₄₀ diene ligand which is coordinated to M in a metallocyclopentene fashion.

When M is in the +3 oxidation state, in formula 5, j=1 and Q is either 1) a monovalent anionic stabilizing ligand selected from the group consisting of alkyl, cycloalkyl, aryl, silyl, amido, phosphido, alkoxy, aryloxy, sulfido groups, and mixtures thereof, and being further substituted with an amine, phosphine, ether, or thioether containing substituent able to form a coordinate-covalent bond or chelating bond with M said ligand having up to 50 atoms not counting hydrogen; or 2) a C₃₋₁₀ hydrocarbyl group comprising an ethylenic unsaturation able to form an η³ bond with M.

Also, when M is in the +3 oxidation state, in formula 6, j=2, Q independently each occurrence is halide, hydride, hydrocarbyl, silylhydrocarbyl, hydrocarbyloxide, dihydrocarbylamide, said Q having up to 20 atoms not counting hydrogen. Alternatively, two Q groups may be joined together to form an alkanediyl group or a conjugated C₄₋₄₀ diene ligand which is coordinated to M in a metallocyclopentene fashion.

When M is in the +2 oxidation state, in formula 4, j=1 and Q is a neutral conjugated diene, optionally substituted with one or more tri(hydrocarbyl)silyl or tri(hydrocarbylsilyl)hydrocarbyl groups, said Q having up to 40 carbon atoms and forming a π-complex with M.

Specific examples of the above metal complexes wherein M is in the +4 oxidation state are shown below in formulas 4a, 5a and 7a, wherein the definitions of M, T, t, Z, Y, R¹, R², and R³ are as defined above with respect to formulas 4-7:

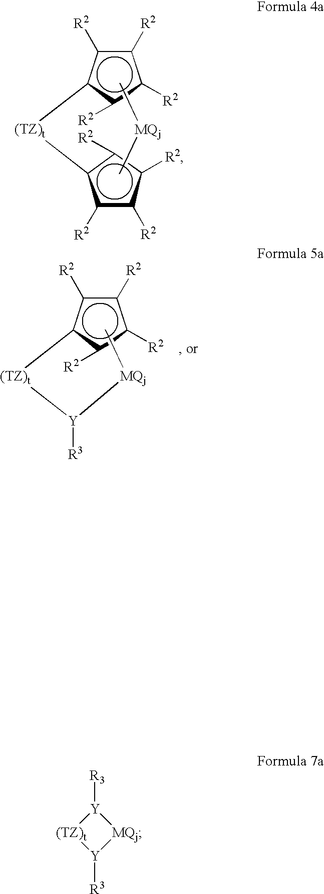

and wherein j is 2, and Q, independently each occurrence is a halide, hydrocarbyl, hydrocarbyloxy, or dihydrocarbylamide group of up to 10 atoms not counting hydrogen, or two Q groups together form a C₄₋₂₀ diene ligand coordinated to M in a metallocyclopentene fashion. Most highly preferably Q independently each occurrence is chloride, trimethylsilylmethyl, or a C₁₋₆ hydrocarbyl group, especially methyl or benzyl, or two Q groups together form a 2-methyl-1,3-butadienyl or 2,3-dimethyl-1,3-butadienyl group.

Specific examples of the above metal complexes wherein M is in the +3 oxidation state are shown below in formulas 4b, 4b, 6b and 7b, wherein the definitions of M, Z, T, t, Y, R¹, R², and R³ are as defined above with respect to formulas 4-7:

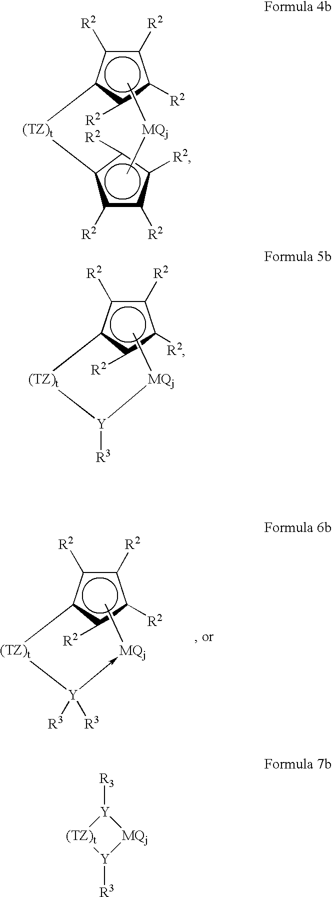

and wherein, for formulas 4b, 5b, and 7b, j is 1, and for formula 6b, j is 2; and

wherein for formulas 4b, 6b and 7b, Q is as defined above, and for formula 5b, Q is a monovalent anionic stabilizing ligand selected from the group consisting of alkyl, cycloalkyl, aryl, and silyl groups which are further substituted with one or more amine, phosphine, or ether substituents able to form a coordinate-covalent bond or chelating bond with M, said Q having up to 30 non-hydrogen atoms; or Q is a C₃₋₁₀ hydrocarbyl group comprising an ethylenic unsaturation able to form an bond with M. Most highly preferred examples of such Q ligands are 2-N,N-dimethylaminobenzyl, allyl, and 1-methylallyl.

Specific examples of the above metal complexes wherein M is in the +2 oxidation state are shown below in formulas 4c, 5c and 7c, wherein the definitions of M, Z, T, t, Y, R¹, R², and R³ are as defined above with respect to formulas 4-7:

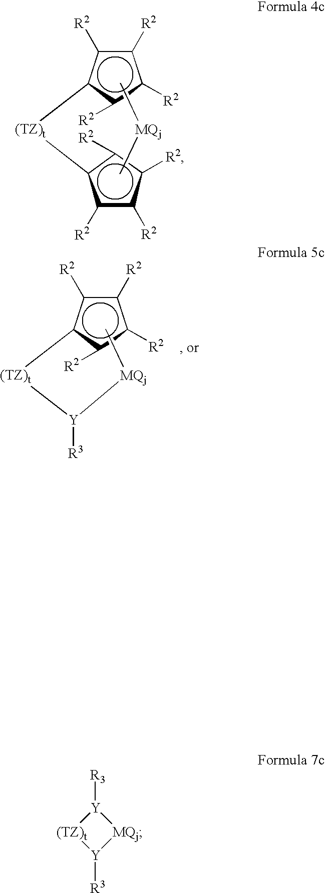

and wherein j is 1, and Q, each occurrence is a neutral conjugated diene, optionally substituted with one or more tri(hydrocarbyl)silyl groups or tri(hydrocarbyl)silylhydrocarbyl groups, said Q having up to 30 atoms not counting hydrogen and forming a π-complex with M. Most highly preferred Q groups are 1,4-diphenyl-1,3-butadiene, 1,3-pentadiene, 3-methyl-1,3-pentadiene, 2,4-hexadiene, 1-phenyl-1,3-pentadiene, 1,4-dibenzyl-1,3-butadiene, 1,4-ditolyl-1,3-butadiene, 1,4-bis(trimethylsilyl)-1,3-butadiene, and 1,4-dinaphthyl-1,3-butadiene.

Preferably in the foregoing formulas 4, 5, 6, 7, 4a, 4b, 4c, 5a, 5b, 5c, 6b, 7a, 7b, and 7c, R¹ independently each occurrence is C₁₋₄ alkyl, or phenyl more preferably methyl or isopropyl, most preferably methyl, Y¹ and Y² are both inden-1-yl, 2-(C₁₋₄)alkyl-4-(C₆₋₁₀)arylinden-1-yl, 3-(C₁₋₄)alkylinden-1-yl, or 3-(1-pyrrolidinyl)-inden-1-yl), or Y¹ is cyclopentadienyl or (C₁₋₄)alkyl-substituted cyclopentadienyl and Y² is fluorenyl; Z is indium and Q is halide, (C₁₋₄)alkyl, benzyl, or 1,4-diphenyl-1,3-butadiene.

Even more preferably in formulas 4 and 4a-c, M is zirconium or hafnium, Z is indium and R¹ is methyl or isopropyl, most preferably methyl. During synthesis of these complexes, the use of methyl R¹ groups gives elevated, often quantitive, yields of the rac isomer. Even more preferably, in formulas 5, 6, 5a-c, and 6b, M is titanium, Z is indium, Y is nitrogen and R¹ is C₁₋₄ alkyl or phenyl, most preferably methyl or isopropyl.

Most highly preferred metal complexes are those of formulas 4a, 4b, or 4c wherein Y¹ and Y² are both inden-1-yl, 2-methyl-4-phenylinden-1-yl, or 2-methyl-4-naphthylinden-1-yl groups, especially compositions comprising greater than 90 percent rac isomer.

Specific, but not limiting, metal complexes included with the invention described in the foregoing formulas are:

dimethylamidogallium-bis-(cyclopentadienyl) zirconium dichloride;

dimethylamidogallium-bis-(cyclopentadienyl) zirconium dimethyl;

dimethylamidogallium-bis-(cyclopentadienyl) zirconium 2-(N,N-dimethylamino)benzyl;

dimethylamidogallium-bis-(cyclopentadienyl) zirconium 1,4-diphenyl-1,3-butadiene;

dimethylamidogallium-bis-(n-butylcyclopentadienyl) zirconium dichloride;

dimethylamidogallium-bis-(n-butylcyclopentadienyl) zirconium dimethyl;

dimethylamidogallium-bis-(n-butylcyclopentadienyl) zirconium 2-(N,N-dimethylamino)benzyl;

dimethylamidogallium-bis-(n-butylcyclopentadienyl) zirconium 1,4-diphenyl-1,3-butadiene;

dimethylamidogallium-bis-(inden-1-yl)zirconium dichloride;

dimethylamidogallium-bis-(inden-1-yl)zirconium dimethyl;

dimethylamidogallium-bis-(inden-1-yl)zirconium 2-(N,N-dimethylamino)benzyl;

dimethylamidogallium-bis-(inden-1-yl)zirconium 1,4-diphenyl 1,3-butadiene;

dimethylamidogallium-bis-(2-methyl-4-phenylinden-1-yl)zirconium dichloride;

dimethylamidogallium-bis-(2-methyl-4-phenylinden-1-yl)zirconium dimethyl;

dimethylamidogallium-bis-(2-methyl-4-phenylinden-1-yl)zirconium 2-(N,N-dimethylamino)benzyl;

dimethylamidogallium-bis-(2-methyl-4-phenylinden-1-yl)zirconium 1,4-diphenyl 1,3-butadiene;

dimethylamidogallium-bis-(3-(1-pyrrolidinyl)inden-1-yl)zirconium dichloride;

dimethylamidogallium-bis-(3-(1-pyrrolidinyl)inden-1-yl)zirconium dimethyl;

dimethylamidogallium-bis-(3-(1-pyrrolidinyl)inden-1-yl)zirconium 2-(N,N-dimethylamino)benzyl;

dimethylamidogallium-bis-(3-(1-pyrrolidinyl)inden-1-yl)zirconium 1,4-diphenyl-1,3-butadiene;

diisopropylamidogallium-bis-(cyclopentadienyl) zirconium dichloride;

diisopropylamidogallium-bis-(cyclopentadienyl) zirconium dimethyl;

diisopropylamidogallium-bis-(cyclopentadienyl) zirconium 2-(N,N-dimethylamino)benzyl;

diisopropylamidogallium-bis-(cyclopentadienyl) zirconium 1,4-diphenyl-1,3-butadiene;

diisopropylamidogallium-bis-(n-butylcyclopentadienyl) zirconium dichloride;

diisopropylamidogallium-bis-(n-butylcyclopentadienyl) zirconium dimethyl;

diisopropylamidogallium-bis-(n-butylcyclopentadienyl) zirconium 2-(N,N-dimethylamino)benzyl;

diisopropylamidogallium-bis-(n-butylcyclopentadienyl) zirconium 1,4-diphenyl-1,3-butadiene;

diisopropylamidogallium-bis-(inden-1-yl)zirconium dichloride;

diisopropylamidogallium-bis-(inden-1-yl)zirconium dimethyl;

diisopropylamidogallium-bis-(inden-1-yl)zirconium 2-(N,N-dimethylamino)benzyl;

diisopropylamidogallium-bis-(inden-1-yl)zirconium 1,4-diphenyl1,3-butadiene;

diisopropylamidogallium-bis-(2-methyl-4-phenylinden-1-yl)zirconium dichloride;

diisopropylamidogallium-bis-(2-methyl-4-phenylinden-1-yl)zirconium dimethyl;

diisopropylamidogallium-bis-(2-methyl-4-phenylinden-1-yl)zirconium 2-(N,N-dimethylamino)benzyl;

diisopropylamidogallium-bis-(2-methyl-4-phenylinden-1-yl)zirconium 1,4-diphenyl 1,3-butadiene;

diisopropylamidogallium-bis-(3-(1-pyrrolidinyl)inden-1-yl)zirconium dichloride;

diisopropylamidogallium-bis-(3-(1-pyrrolidinyl)inden-1-yl)zirconium dimethyl;

diisopropylamidogallium-bis-(3-(1-pyrrolidinyl)inden-1-yl)zirconium 2-(N,N-dimethylamino)benzyl;

diisopropylamidogallium-bis-(3-(1-pyrrolidinyl)inden-1-yl)zirconium 1,4-diphenyl-1,3-butadiene;

bis(trimethylsilylmethyl)amidogallium-bis-(cyclopentadienyl) zirconium dichloride;

bis(trimethylsilylmethyl)amidogallium-bis-(cyclopentadienyl) zirconium dimethyl;

bis(trimethylsilylmethyl)amidogallium-bis-(cyclopentadienyl) zirconium 2-(N,N-dimethylamino)benzyl;

bis(trimethylsilylmethyl)amidogallium-bis-(cyclopentadienyl) zirconium η⁴-1,4-diphenyl-1,3-butadiene;

bis(trimethylsilylmethyl)amidogallium-bis-(n-butylcyclopentadienyl) zirconium dichloride;

bis(trimethylsilylmethyl)amidogallium-bis-(n-butylcyclopentadienyl) zirconium dimethyl;

bis(trimethylsilylmethyl)amidogallium-bis-(n-butylcyclopentadienyl) zirconium 2-(N,N-dimethylamino)benzyl;

bis(trimethylsilylmethyl)amidogallium-bis-(n-butylcyclopentadienyl) zirconium η⁴-1,4-diphenyl-1,3-butadiene;

bis(trimethylsilylmethyl)amidogallium-bis-(inden-1-yl) zirconium dichloride;

bis(trimethylsilylmethyl)amidogallium-bis-(inden-1-yl)zirconium dimethyl;

bis(trimethylsilylmethyl)amidogallium-bis-(inden-1-yl) zirconium 2-(N,N-dimethylamino)benzyl;

bis(trimethylsilylmethyl)amidogallium-bis-(inden-1-yl)zirconium η⁴-1,4-diphenyl-1,3-butadiene;

bis(trimethylsilylmethyl)amidogallium-bis-(2-methyl-4-phenylinden-1-yl)zirconium dichloride;

bis(trimethylsilylmethyl)amidogallium-bis-(2-methyl-4-phenylinden-1-yl)zirconium dimethyl;

bis(trimethylsilylmethyl)amidogallium-bis-(2-methyl-4-phenylinden-1-yl)zirconium 2-(N,N-dimethylamino)benzyl;

bis(trimethylsilylmethyl)amidogallium-bis-(2-methyl-4-phenylinden-1-yl)zirconium η⁴-1,4-diphenyl-1,3-butadiene;

bis(trimethylsilylmethyl)amidogallium-bis-(3-(1-pyrrolidinyl)inden-1-yl)zirconium dichloride;

bis(trimethylsilylmethyl)amidogallium-bis-(3-(1-pyrrolidinyl)inden-1-yl)zirconium dimethyl;

bis(trimethylsilylmethyl)amidogallium-bis-(3-(1-pyrrolidinyl)inden-1-yl)zirconium 2-(N,N-dimethylamino)benzyl;

bis(trimethylsilylmethyl)amidogallium-bis-(3-(1-pyrrolidinyl)inden-1-yl)zirconium 1,4-diphenyl-1,3-butadiene;

dimethylamidoindium-bis-(cyclopentadienyl) zirconium dichloride;

dimethylamidoindium-bis-(cyclopentadienyl) zirconium dimethyl;

dimethylamidoindium-bis-(cyclopentadienyl) zirconium 2-(N,N-dimethylamino)benzyl;

dimethylamidoindium-bis-(cyclopentadienyl) zirconium 1,4-diphenyl-1,3-butadiene;

dimethylamidoindium-bis-(n-butylcyclopentadienyl) zirconium dichloride;

dimethylamidoindium-bis-(n-butylcyclopentadienyl) zirconium dimethyl;

dimethylamidoindium-bis-(n-butylcyclopentadienyl) zirconium 2-(N,N-dimethylamino)benzyl;

dimethylamidoindium-bis-(n-butylcyclopentadienyl) zirconium 1,4-diphenyl-1,3-butadiene;

dimethylamidoindium-bis-(inden-1-yl)zirconium dichloride;

dimethylamidoindium-bis-(inden-1-yl)zirconium dimethyl;

dimethylamidoindium-bis-(inden-1-yl)zirconium 2-(N,N-dimethylamino)benzyl;

dimethylamidoindium-bis-(inden-1-yl)zirconium 1,4-diphenyl 1,3-butadiene;

dimethylamidoindium-bis-(2-methyl-4-phenylinden-1-yl)zirconium dichloride;

dimethylamidoindium-bis-(2-methyl-4-phenylinden-1-yl)zirconium dimethyl;

dimethylamidoindium-bis-(2-methyl-4-phenylinden-1-yl)zirconium 2-(N,N-dimethylamino)benzyl;

dimethylamidoindium-bis-(2-methyl-4-phenylinden-1-yl)zirconium 1,4-diphenyl 1,3-butadiene;

dimethylamidoindium-bis-(3-(1-pyrrolidinyl)inden-1-yl)zirconium dichloride;

dimethylamidoindium-bis-(3-(1-pyrrolidinyl)inden-1-yl)zirconium dimethyl;

dimethylamidoindium-bis-(3-(1-pyrrolidinyl)inden-1-yl)zirconium 2-(N,N-dimethylamino)benzyl;

dimethylamidoindium-bis-(3-(1-pyrrolidinyl)inden-1-yl)zirconium 1,4-diphenyl-1,3-butadiene;

diisopropylamidoindium-bis-(cyclopentadienyl) zirconium dichloride;

diisopropylamidoindium-bis-(cyclopentadienyl) zirconium dimethyl;

diisopropylamidoindium-bis-(cyclopentadienyl) zirconium 2-N,N-dimethylamino)benzyl;

diisopropylamidoindium-bis-(cyclopentadienyl) zirconium 1,4-diphenyl-1,3-butadiene;

diisopropylamidoindium-bis-(n-butylcyclopentadienyl) zirconium dichloride;

diisopropylamidoindium-bis-(n-butylcyclopentadienyl) zirconium dimethyl;

diisopropylamidoindium-bis-(n-butylcyclopentadienyl) zirconium 2-(N,N-dimethylamino)benzyl;

diisopropylamidoindium-bis-(n-butylcyclopentadienyl) zirconium 1,4-diphenyl-1,3-butadiene;

diisopropylamidoindium-bis-(inden-1-yl) zirconium dichloride;

diisopropylamidoindium-bis-(inden-1-yl) zirconium dimethyl;

diisopropylamidoindium-bis-(inden-1-yl) zirconium 2-(N,N-dimethylamino)benzyl;

diisopropylamidoindium-bis-(inden-1-yl) zirconium 1,4-diphenyl1,3-butadiene;

diisopropylamidoindium-bis-(2-methyl-4-phenylinden-1-yl)zirconium dichloride;

diisopropylamidoindium-bis-(2-methyl-4-phenylinden-1-yl)zirconium dimethyl;

diisopropylamidoindium-bis-(2-methyl-4-phenylinden-1-yl)zirconium 2-(N,N-dimethylamino)benzyl;

diisopropylamidoindium-bis-(2-methyl-4-phenylinden-1-yl)zirconium 1,4-diphenyl 1,3-butadiene;

diisopropylamidoindium-bis-(3-(1-pyrrolidinyl)inden-1-yl)zirconium dichloride; diisopropylamidoindium-bis-(3-(1-pyrrolidinyl)inden-1-yl)zirconium dimethyl;

diisopropylamidoindium-bis-(3-(1-pyrrolidinyl)inden-1-yl)zirconium 2-(N,N-dimethylamino)benzyl;

diisopropylamidoindium-bis-(3-(1-pyrrolidinyl)inden-1-yl)zirconium 1,4-diphenyl-1,3-butadiene;

bis(trimethylsilylmethyl)amidoindium-bis-(cyclopentadienyl) zirconium dichloride;

bis(trimethylsilylmethyl)amidoindium-bis-(cyclopentadienyl) zirconium dimethyl;

bis(trimethylsilylmethyl)amidoindium-bis-(cyclopentadienyl) zirconium 2-(N,N-dimethylamino)benzyl;

bis(trimethylsilylmethyl)amidoindium-bis-(cyclopentadienyl) zirconium 1,4-diphenyl-1,3-butadiene;

bis(trimethylsilylmethyl)amidoindium-bis-(n-butylcyclopentadienyl) zirconium dichloride;

bis(trimethylsilylmethyl)amidoindium-bis-(n-butylcyclopentadienyl) zirconium dimethyl;

bis(trimethylsilylmethyl)amidoindium-bis-(n-butylcyclopentadienyl) zirconium 2-(N,N-dimethylamino)benzyl;

bis(trimethylsilylmethyl)amidoindium-bis-(n-butylcyclopentadienyl) zirconium 1,4-diphenyl-1,3-butadiene;

bis(trimethylsilylmethyl)amidoindium-bis-(inden-1-yl)zirconium dichloride;

bis(trimethylsilylmethyl)amidoindium-bis-(inden-1-yl) zirconium dimethyl; bis(trimethylsilylmethyl)amidoindium-bis-(inden-1-yl)zirconium 2-(N,N-dimethylamino)benzyl;

bis(trimethylsilylmethyl)amidoindium-bis-(inden-1-yl)zirconium 1,4-diphenyl-1,3-butadiene;

bis(trimethylsilylmethyl)amidoindium-bis-(2-methyl-4-phenylinden-1-yl)zirconium dichloride;

bis(trimethylsilylmethyl)amidoindium-bis-(2-methyl-4-phenylinden-1-yl)zirconium dimethyl;

bis(trimethylsilylmethyl)amidoindium-bis-(2-methyl-4-phenylinden-1-yl)zirconium 2-(N,N-dimethylamino)benzyl;

bis(trimethylsilylmethyl)amidoindium-bis-(2-methyl-4-phenylinden-1-yl)zirconium 1,4-diphenyl-1,3-butadiene;

bis(trimethylsilylmethyl)amidoindium-bis-(3-(1-pyrrolidinyl)inden-1-yl)zirconium dichloride;

bis(trimethylsilylmethyl)amidoindium-bis-(3-(1-pyrrolidinyl)inden-1-yl)zirconium dimethyl;

bis(trimethylsilylmethyl)amidoindium-bis-(3-(1-pyrrolidinyl)inden-1-yl)zirconium 2-(N,N-dimethylamino)benzyl; and

bis(trimethylsilylmethyl)amidoindium-bis-(3-(1-pyrrolidinyl)inden-1-yl)zirconium 1,4-diphenyl-1,3-butadiene.

A further preferred class of Group 4 transition metal complexes of the present invention are represented in previously defined formulas 4-7 wherein T is:

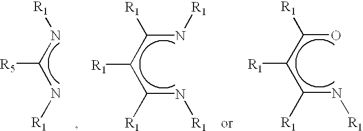

including such structures where two R¹ groups and R⁵ are linked such as in 1,3,4,6,7,8, hexahydro-pyrimido[1,2-a] pyrimidinate, shown below:

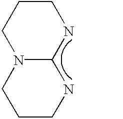

In the foregoing species, it is believed, without wishing to be bound by such belief, that the ligand group, T, is connected to Z via the heteroatoms thereof.

Specific, but not limiting, examples of the foregoing metal complexes included within the invention are:

1,3-diisopropyl-2-t-butyl-amidinatogallium-bis-(cyclopentadienyl)zirconium dichloride;

1,3-diisopropyl-2-t-butyl-amidinatogallium-bis-(cyclopentadienyl)zirconium dimethyl;

1,3-diisopropyl-2-t-butyl-amidinatogallum-bis-(cyclopentadienyl)zirconium 2-(N,N-dimethylamino)benzyl;

1,3-diisopropyl-2-t-butyl-amidinatogallium-bis-(cyclopentadienyl)zirconium 1,4-diphenyl-1,3-butadiene;

1,3-diisopropyl-2-t-butyl-amidinatogallium-bis-(n-butylcyclopentadienyl) zirconium dichloride;

1,3-diisopropyl-2-t-butyl-amidinatogallium-bis-(n-butylcyclopentadienyl) zirconium dimethyl;

1,3-diisopropyl-2-t-butyl-amidinatogallium-bis-(n-butylcyclopentadienyl) zirconium 2-(N,N-dimethylamino)benzyl;

1,3-diisopropyl-2-t-butyl-amidinatogallium-bis-(n-butylcyclopentadienyl) zirconium 1,4-diphenyl-1,3-butadiene;

1,3-diisopropyl-2-t-butyl-amidinatogallium-bis-(inden-1-yl) zirconium dichloride;

1,3-diisopropyl-2-t-butyl-amidinatogallium-bis-(inden-1-yl) zirconium dimethyl;

1,3-diisopropyl-2-t-butyl-amidinatogallum-bis-(inden-1-yl) zirconium 2-(N,N-dimethylamino)benzyl;

1,3-diisopropyl-2-t-butyl-amidinatogallium-bis-(inden-1-yl) zirconium 1,4-diphenyl-1,3-butadiene;

1,3-diisopropyl-2-t-butyl-amidinatogallium-bis-(2-methyl-4-phenylinden-1-yl) zirconium dichloride;

1,3-diisopropyl-2-t-butyl-amidinatogallium-bis-(2-methyl-4-phenylinden-1-yl) zirconium dimethyl;

1,3-diisopropyl-2-t-butyl-amidinatogallum-bis-(2-methyl-4-phenylinden-1-yl) zirconium 2-(N,N-dimethylamino)benzyl;

1,3-diisopropyl-2-t-butyl-amidinatogallium-bis-(2-methyl-4-phenylinden-1-yl) zirconium 1,4-diphenyl-1,3-butadiene;

1,3-diisopropyl-2-t-butyl-amidinatogallium-bis-(3-(1-pyrrolidinyl)inden-1-yl)zirconium dichloride;

1,3-diisopropyl-2-t-butyl-amidinatogallium-bis-(3-(1-pyrrolidinyl)inden-1-yl)zirconium dimethyl;

1,3-diisopropyl-2-t-butyl-amidinatogallium-bis-(3-(1-pyrrolidinyl)inden-1-yl)zirconium 2-(N,N-dimethylamino)benzyl;

1,3-diisopropyl-2-t-butyl-amidinatogallium-bis-(3-(1-pyrrolidinyl)inden-1-yl)zirconium 1,4-diphenyl-1,3-butadiene;

1,3-diisopropyl-2-phenyl-amidinatogallium-bis-(cyclopentadienyl)zirconium dichloride;

1,3-diisopropyl-2-phenyl-amidinatogallium-bis-(cyclopentadienyl)zirconium dimethyl;

1,3-diisopropyl-2-phenyl-amidinatogallum-bis-(cyclopentadienyl)zirconium 2-(N,N-dimethylamino)benzyl;

1,3-diisopropyl-2-phenyl-amidinatogallium-bis-(cyclopentadienyl)zirconium 1,4-diphenyl-1,3-butadiene;

1,3-diisopropyl-2-phenyl-amidinatogallium-bis-(n-butylcyclopentadienyl) zirconium dichloride;

1,3-diisopropyl-2-phenyl-amidinatogallium-bis-(n-butylcyclopentadienyl) zirconium dimethyl;

1,3-diisopropyl-2-phenyl-amidinatogallium-bis-(n-butylcyclopentadienyl) zirconium 2-(N,N-dimethylamino)benzyl;

1,3-diisopropyl-2-phenyl-amidinatogallium-bis-(n-butylcyclopentadienyl) zirconium 1,4-diphenyl-1,3-butadiene;

1,3-diisopropyl-2-phenyl-amidinatogallium-bis-(inden-1-yl) zirconium dichloride;

1,3-diisopropyl-2-phenyl-amidinatogallium-bis-(inden-1-yl) zirconium dimethyl;

1,3-diisopropyl-2-phenyl-amidinatogallum-bis-(inden-1-yl) zirconium 2-(N,N-dimethylamino)benzyl;

1,3-diisopropyl-2-phenyl-amidinatogallium-bis-(inden-1-yl) zirconium 1,4-diphenyl-1,3-butadiene;

1,3-diisopropyl-2-phenyl-amidinatogallium-bis-(2-methyl-4-phenylinden-1-yl) zirconium dichloride;

1,3-diisopropyl-2-phenyl-amidinatogallium-bis-(2-methyl-4-phenylinden-1-yl) zirconium dimethyl;

1,3-diisopropyl-2-phenyl-amidinatogallum-bis-(2-methyl-4-phenylinden-1-yl) zirconium 2-(N,N-dimethylamino)benzyl;

1,3-diisopropyl-2-phenyl-amidinatogallium-bis-(2-methyl-4-phenylinden-1-yl) zirconium 1,4-diphenyl-1,3-butadiene;

1,3-diisopropyl-2-phenyl-amidinatogallium-bis-(3-(1-pyrrolidinyl)inden-1-yl)zirconium dichloride;

1,3-diisopropyl-2-phenyl-amidinatogallium-bis-(3-(1-pyrrolidinyl)inden-1-yl)zirconium dimethyl;

1,3-diisopropyl-2-phenyl-amidinatogallium-bis-(3-(1-pyrrolidinyl)inden-1-yl)zirconium 2-(N,N-dimethylamino)benzyl;

1,3-diisopropyl-2-phenyl-amidinatogallium-bis-(3-(1-pyrrolidinyl)inden-1-yl)zirconium 1,4-diphenyl-1,3-butadiene;

N,N′-diisopropyl-3-t-butyl-1,3-diketimine gallium-bis-(cyclopentadienyl)zirconium dichloride;

N,N′-diisopropyl-3-t-butyl-1,3-diketimine gallium-bis-(cyclopentadienyl)zirconium dimethyl;

N,N′-diisopropyl-3-t-butyl-1,3-diketimine gallium-bis-(cyclopentadienyl)zirconium 2-(N,N-dimethylamino)benzyl;

N,N′-diisopropyl-3-t-butyl-1,3-diketimine gallium-bis-(cyclopentadienyl)zirconium 1,diphenyl-1,3-butadiene;

N,N′-diisopropyl-3-t-butyl-1,3-diketimine gallium-bis-(n-butylcyclopentadienyl) zirconium dichloride;

N,N′-diisopropyl-3-t-butyl-1,3-diketimine gallium-bis-(n-butylcyclopentadienyl) zirconium dimethyl;

N,N′-diisopropyl-3-t-butyl-1,3-diketimine gallium-bis-(n-butylcyclopentadienyl) zirconium 2-(N,N-dimethylamino)benzyl;

N,N′-diisopropyl-3-t-butyl-1,3-diketimine gallium-bis-(n-butylcyclopentadienyl) zirconium 1,diphenyl-1,3-butadiene;

N,N ′-diisopropyl-3-t-butyl-1,3-diketimine gallium-bis-(inden-1-yl)zirconium dichloride;

N,N′-diisopropyl-3-t-butyl-1,3-diketimine gallium-bis-(inden-1-yl)zirconium dimethyl;

N,N′-diisopropyl-3-t-butyl-1,3-diketimine gallium-bis-(inden-1-yl)zirconium 2-(N,N-dimethylamino)benzyl;

N,N ′-diisopropyl-3-t-butyl-1,3-diketimine gallium-bis-(inden-1-yl)zirconium 1,diphenyl-1,3-butadiene;

N,N′-diisopropyl-3-t-butyl-1,3-diketimine gallium-bis-(2-methyl-4-phenylinden-1-yl)zirconium dichloride;

N,N′-diisopropyl-3-t-butyl-1,3-diketimine gallium-bis-(2-methyl-4-phenylinden-1-yl)zirconium dimethyl;

N,N ′-diisopropyl-3-t-butyl-1,3-diketimine gallium-bis-(2-methyl-4-phenylinden-1-yl)zirconium 2-(N,N-dimethylamino)benzyl;

N,N′-diisopropyl-3-t-butyl-1,3-diketimine gallium-bis-(2-methyl-4-phenylinden-1-yl)zirconium 1,diphenyl-1,3-butadiene;

N,N′-diisopropyl-3-t-butyl-1,3-diketimine gallium-bis-(3-(1-pyrrolidinyl)inden-1-yl)zirconium dichloride;

N,N′-diisopropyl-3-t-butyl-1,3-diketimine gallium-bis-(3-(1-pyrrolidinyl)inden-1-yl)zirconium dimethyl;

N,N′-diisopropyl-3-t-butyl-1,3-diketimine gallium-bis-(3-(1-pyrrolidinyl)inden-1-yl)zirconium 2-(N,N-dimethylamino)benzyl;

N,N′-diisopropyl-3-t-butyl-1,3-diketimine gallium-bis-(3-(1-pyrrolidinyl)inden-1-yl)zirconium 1,diphenyl-1,3-butadiene;

N,N′-diisopropyl-3-phenyl-1,3-diketimine gallium-bis-(cyclopentadienyl) zirconium dichloride;

N,N′-diisopropyl-3-phenyl-1,3-diketimine gallium-bis-(cyclopentadienyl) zirconium dimethyl;

N,N′-diisopropyl-3-phenyl-1,3-diketimine gallium-bis-(cyclopentadienyl) zirconium 2-(N,N-dimethylamino)benzyl;

N,N′-diisopropyl-3-phenyl-1,3-diketimine gallium-bis-(cyclopentadienyl) zirconium 1,diphenyl-1,3-butadiene;

N,N′-diisopropyl-3-phenyl-1,3-diketimine gallium-bis-(n-butylcyclopentadienyl) zirconium dichloride;

N,N′-diisopropyl-3-phenyl-1,3-diketimine gallium-bis-(n-butylcyclopentadienyl) zirconium dimethyl;

N,N′-diisopropyl-3-phenyl-1,3-diketimine gallium-bis-(n-butylcyclopentadienyl) zirconium 2-(N,N-dimethylamino)benzyl;

N,N′-diisopropyl-3-phenyl-1,3-diketimine gallium-bis-(n-butylcyclopentadienyl) zirconium 1,diphenyl-1,3-butadiene;

N,N′-diisopropyl-3-phenyl-1,3-diketimine gallium-bis-(inden-1-yl) zirconium dichloride;

N,N′-diisopropyl-3-phenyl-1,3-diketimine gallium-bis-(inden-1-yl) zirconium dimethyl;

N,N′-diisopropyl-3-phenyl-1,3-diketimine gallium-bis-(inden-1-yl) zirconium 2-(N,N-dimethylamino)benzyl;

N,N′-diisopropyl-3-phenyl-1,3-diketimine gallium-bis-(inden-1-yl) zirconium 1,diphenyl-1,3-butadiene;

N,N′-diisopropyl-3-phenyl-1,3-diketimine gallium-bis-(2-methyl-4-phenylinden-1-yl) zirconium dichloride;

N,N′-diisopropyl-3-phenyl-1,3-diketimine gallium-bis-(2-methyl-4-phenylinden-1-yl) zirconium dimethyl;

N,N′-diisopropyl-3-phenyl-1,3-diketimine gallium-bis-(2-methyl-4-phenylinden-1-yl) zirconium 2-(N,N-dimethylamino)benzyl;

N,N′-diisopropyl-3-phenyl-1,3-diketimine gallium-bis-(2-methyl-4-phenylinden-1-yl) zirconium 1,diphenyl-1,3-butadiene;

N,N′-diisopropyl-3-phenyl-1,3-diketimine gallium-bis-(3-(1-pyrrolidinyl)inden-1-yl) zirconium dichloride;

N,N′-diisopropyl-3-phenyl-1,3-diketimine gallium-bis-(3-(1-pyrrolidinyl)inden-1-yl) zirconium dimethyl;

N,N′-diisopropyl-3-phenyl-1,3-diketimine gallium-bis-(3-(1-pyrrolidinyl)inden-1-yl) zirconium 2-(N,N-dimethylamino)benzyl;

N,N′-diisopropyl-3-phenyl-1,3-diketimine gallium-bis-(3-(1-pyrrolidinyl)inden-1-yl) zirconium 1,diphenyl-1,3-butadiene;

N,N′-diisopropyl-dimethylguanidinate gallium-bis-(cyclopentadienyl) zirconium dichloride;

N,N′-diisopropyl-dimethylguanidinate gallium-bis-(cyclopentadienyl) zirconium dimethyl;

N,N′-diisopropyl-dimethylguanidinate gallium-bis-(cyclopentadienyl) zirconium 2-(N,N-dimethylamino)benzyl;

N,N′-diisopropyl-dimethylguanidinate gallium-bis-(cyclopentadienyl) zirconium 1,diphenyl-1,3-butadiene;

N,N′-diisopropyl-dimethylguanidinate gallium-bis-(n-butylcyclopentadienyl) zirconium dichloride;

N,N′-diisopropyl-dimethylguanidinate gallium-bis-(n-butylcyclopentadienyl) zirconium dimethyl;

N,N′-diisopropyl-dimethylguanidinate gallium-bis-(n-butylcyclopentadienyl) zirconium 2-(N,N-dimethylamino)benzyl;

N,N′-diisopropyl-dimethylguanidinate gallium-bis-(n-butylcyclopentadienyl) zirconium 1,diphenyl-1,3-butadiene;

N,N′-diisopropyl-dimethylguanidinate gallium-bis-(inden-1-yl) zirconium dichloride;

N,N′-diisopropyl-dimethylguanidinate gallium-bis-(inden-1-yl) zirconium dimethyl;

N,N′-diisopropyl-dimethylguanidinate gallium-bis-(inden-1-yl) zirconium 2-(N,N-dimethylamino)benzyl;

N,N′-diisopropyl-dimethylguanidinate gallium-bis-(inden-1-yl) zirconium 1,diphenyl-1,3-butadiene;

N,N′-diisopropyl-dimethylguanidinate gallium-bis-(2-methyl-4-phenylinden-1-yl) zirconium dichloride;

N,N′-diisopropyl-dimethylguanidinate gallium-bis-(2-methyl-4-phenylinden-1-yl) zirconium dimethyl;

N,N′-diisopropyl-dimethylguanidinate gallium-bis-(2-methyl-4-phenylinden-1-yl) zirconium 2-(N,N-dimethylamino)benzyl;

N,N′-diisopropyl-dimethylguanidinate gallium-bis-(2-methyl-4-phenylinden-1-yl) zirconium 1,diphenyl-1,3-butadiene;

N,N′-diisopropyl-dimethylguanidinate gallium-bis-(3-(1-pyrrolidinyl)inden-1-yl) zirconium dichloride;

N,N′-diisopropyl-dimethylguanidinate gallium-bis-(3-(1-pyrrolidinyl)inden-1-yl) zirconium dimethyl;

N,N′-diisopropyl-dimethylguanidinate gallium-bis-(3-(1-pyrrolidinyl)inden-1-yl) zirconium 2-(N,N-dimethylamino)benzyl;

N,N′-diisopropyl-dimethylguanidinate gallium-bis-(3-(1-pyrrolidinyl)inden-1-yl) zirconium 1,diphenyl-1,3-butadiene;

1,3,4,6,7,8-hexahydro-pyrimido[1,2-a] pyrimidinate gallium-bis-(cyclopentadienyl)zirconium dichloride;

1,3,4,6,7,8-hexahydro-pyrimido[1,2-a] pyrimidinate gallium-bis-(cyclopentadienyl)zirconium dimethyl;

1,3,4,6,7,8-hexahydro-pyrimido[1,2-a] pyrimidinate gallium-bis-(cyclopentadienyl)zirconium 2-(N,N-dimethylamino)benzyl;

1,3,4,6,7,8-hexahydro-pyrimido[1,2-a] pyrimidinate gallium-bis-(cyclopentadienyl)zirconium 1,diphenyl-1,3-butadiene;

1,3,4,6,7,8-hexahydro-pyrimido[1,2-a] pyrimidinate gallium-bis-(n-butylcyclopentadienyl) zirconium dichloride;

1,3,4,6,7,8-hexahydro-pyrimido[1,2-a] pyrimidinate gallium-bis-(n-butylcyclopentadienyl) zirconium dimethyl;

1,3,4,6,7,8-hexahydro-pyrimido [1,2-a] pyrimidinate gallium-bis-(n-butylcyclopentadienyl) zirconium 2-(N,N-dimethylamino)benzyl;

1,3,4,6,7,8-hexahydro-pyrimido[1,2-a] pyrimidinate gallium-bis-(n-butylcyclopentadienyl) zirconium 1,diphenyl-1,3-butadiene;

1,3,4,6,7,8-hexahydro-pyrimido[1,2-a] pyrimidinate gallium-bis-(inden-1-yl) zirconium dichloride;

1,3,4,6,7,8-hexahydro-pyrimido[1,2-a] pyrimidinate gallium-bis-(inden-1-yl) zirconium dimethyl;

1,3,4,6,7,8-hexahydro-pyrimido[1,2-a] pyrimidinate gallium-bis-(inden-1-yl) zirconium 2-(N,N-dimethylamino)benzyl;

1,3,4,6,7,8-hexahydro-pyrimido[1,2-a] pyrimidinate gallium-bis-(inden-1-yl) zirconium 1,diphenyl-1,3-butadiene;

1,3,4,6,7,8-hexahydro-pyrimido[1,2-a] pyrimidinate gallium-bis-(2-methyl-4-phenylinden-1-yl) zirconium dichloride;

1,3,4,6,7,8-hexahydro-pyrimido[1,2-a] pyrimidinate gallium-bis-(2-methyl-4-phenylinden-1-yl) zirconium dimethyl;

1,3,4,6,7,8-hexahydro-pyrimido[1,2-a] pyrimidinate gallium-bis-(2-methyl-4-phenylinden-1-yl) zirconium 2-(N,N-dimethylamino)benzyl;

1,3,4,6,7,8-hexahydro-pyrimido[1,2-a] pyrimidinate gallium-bis-(2-methyl-4-phenylinden-1-yl) zirconium 1,diphenyl-1,3-butadiene;

1,3,4,6,7,8-hexahydro-pyrimido[1,2-a] pyrimidinate gallium-bis-(3-(1-pyrrolidinyl)inden-1-yl) zirconium dichloride;

1,3,4,6,7,8-hexahydro-pyrimido[1,2-a] pyrimidinate gallium-bis-(3-(1-pyrrolidinyl)inden-1-yl) zirconium dimethyl;

1,3,4,6,7,8-hexahydro-pyrimido[1,2-a] pyrimidinate gallium-bis-(3-(1-pyrrolidinyl)inden-1-yl) zirconium 2-(N,N-dimethylamino)benzyl;

1,3,4,6,7,8-hexahydro-pyrimido[1,2-a] pyrimidinate gallium-bis-(3-(1-pyrrolidinyl)inden-1-yl) zirconium 1,diphenyl-1,3-butadiene;

1,3-diisopropyl-2-t-butyl-amidinatoindium-bis-(cyclopentadienyl)zirconium dichloride;

1,3-diisopropyl-2-t-butyl-amidinatoindium-bis-(cyclopentadienyl)zirconium dimethyl;

1,3-diisopropyl-2-t-butyl-amidinatogallum-bis-(cyclopentadienyl)zirconium 2-(N,N-dimethylamino)benzyl;

1,3-diisopropyl-2-t-butyl-amidinatoindium-bis-(cyclopentadienyl)zirconium 1,4-diphenyl-1,3-butadiene;

1,3-diisopropyl-2-t-butyl-amidinatoindium-bis-(n-butylcyclopentadienyl) zirconium dichloride;

1,3-diisopropyl-2-t-butyl-amidinatoindium-bis-(n-butylcylopentadienyl) zirconium dimethyl;

1,3-diisopropyl-2-t-butyl-amidinatoindium-bis-(n-butylcyclopentadienyl) zirconium 2-(N,N-dimethylamino)benzyl;

1,3-diisopropyl-2-t-butyl-amidinatoindium-bis-(n-butylcyclopentadienyl) zirconium 1,4-diphenyl-1,3-butadiene;

1,3-diisopropyl-2-t-butyl-amidinatoindium-bis-(inden-1-yl) zirconium dichloride;

1,3-diisopropyl-2-t-butyl-amidinatoindium-bis-(inden-1-yl) zirconium dimethyl;

1,3-diisopropyl-2-t-butyl-amidinatogallum-bis-(inden-1-yl) zirconium 2-(N,N-dimethylamino)benzyl;

1,3-diisopropyl-2-t-butyl-amidinatoindium-bis-(inden-1-yl) zirconium 1,4-diphenyl-1,3-butadiene;

1,3-diisopropyl-2-t-butyl-amidinatoindium-bis-(2-methyl-4-phenylinden-1-yl) zirconium dichloride;

1,3-diisopropyl-2-t-butyl-amidinatoindium-bis-(2-methyl-4-phenylinden-1-yl) zirconium dimethyl;

1,3-diisopropyl-2-t-butyl-amidinatogallum-bis-(2-methyl-4-phenylinden-1-yl) zirconium 2-(N,N-dimethylamino)benzyl;

1,3-diisopropyl-2-t-butyl-amidinatoindium-bis-(2-methyl-4-phenylinden-1-yl) zirconium 1,4-diphenyl-1,3-butadiene;

1,3-diisopropyl-2-t-butyl-amidinatoindium-bis-(3-(1-pyrrolidinyl)inden-1-yl)zirconium dichloride;

1,3-diisopropyl-2-t-butyl-amidinatoindium-bis-(3-(1-pyrrolidinyl)inden-1-yl)zirconium dimethyl;

1,3-diisopropyl-2-t-butyl-amidinatoindium-bis-(3-(1-pyrrolidinyl)inden-1-yl)zirconium 2-(N,N-dimethylamino)benzyl;

1,3-diisopropyl-2-t-butyl-amidinatoindium-bis-(3-(1-pyrrolidinyl)inden-1-yl)zirconium 1,4-diphenyl-1,3-butadiene;

1,3-diisopropyl-2-phenyl-amidinatoindium-bis-(cyclopentadienyl)zirconium dichloride;

1,3-diisopropyl-2-phenyl-amidinatoindium-bis-(cyclopentadienyl)zirconium dimethyl;

1,3-diisopropyl-2-phenyl-amidinatogallum-bis-(cyclopentadienyl)zirconium 2-(N,N-dimethylamino)benzyl;

1,3-diisopropyl-2-phenyl-amidinatoindium-bis-(cyclopentadienyl)zirconium 1,4-diphenyl-1,3-butadiene;

1,3-diisopropyl-2-phenyl-amidinatoindium-bis-(n-butylcyclopentadienyl) zirconium dichloride;

1,3-diisopropyl-2-phenyl-amidinatoindium-bis-(n-butylcyclopentadienyl) zirconium dimethyl;

1,3-diisopropyl-2-phenyl-amidinatoindium-bis-(n-butylcyclopentadienyl) zirconium 2-(N,N-dimethylamino)benzyl;

1,3-diisopropyl-2-phenyl-amidinatoindium-bis-(n-butylcyclopentadienyl) zirconium 1,4-diphenyl-1,3-butadiene;

1,3-diisopropyl-2-phenyl-amidinatoindium-bis-(inden-1-yl) zirconium dichloride;

1,3-diisopropyl-2-phenyl-amidinatoindium-bis-(inden-1-yl) zirconium dimethyl;

1,3-diisopropyl-2-phenyl-amidinatogallum-bis-(inden-1-yl) zirconium 2-(N,N-dimethylamino)benzyl;

1,3-diisopropyl-2-phenyl-amidinatoindium-bis-(inden-1-yl) zirconium 1,4-diphenyl-1,3-butadiene;

1,3-diisopropyl-2-phenyl-amidinatoindium-bis-(2-methyl-4-phenylinden-1-yl) zirconium dichloride;

1,3-diisopropyl-2-phenyl-amidinatoindium-bis-(2-methyl-4-phenylinden-1-yl) zirconium dimethyl;

1,3-diisopropyl-2-phenyl-amidinatogallum-bis-(2-methyl-4-phenylinden-1-yl) zirconium 2-(N,N-dimethylamino)benzyl;

1,3-diisopropyl-2-phenyl-amidinatoindium-bis-(2-methyl-4-phenylinden-1-yl) zirconium 1,4-diphenyl-1,3-butadiene;

1,3-diisopropyl-2-phenyl-amidinatoindium-bis-(3-(1-pyrrolidinyl)inden-1-yl)zirconium dichloride;

1,3-diisopropyl-2-phenyl-amidinatoindium-bis-(3-(1-pyrrolidinyl)inden-1-yl)zirconium dimethyl;

1,3-diisopropyl-2-phenyl-amidinatoindium-bis-(3-(1-pyrrolidinyl)inden-1-yl)zirconium 2-(N,N-dimethylamino)benzyl;

1,3-diisopropyl-2-phenyl-amidinatoindium-bis-(3-(1-pyrrolidinyl)inden-1-yl)zirconium 1,4-diphenyl-1,3-butadiene;

N,N′-diisopropyl-3-t-butyl-1,3-diketimine indium-bis-(cyclopentadienyl) zirconium dichloride;

N,N′-diisopropyl-3-t-butyl-1,3-diketimine indium-bis-(cyclopentadienyl) zirconium dimethyl;

N,N′-diisopropyl-3-t-butyl-1,3-diketimine indium-bis-(cyclopentadienyl) zirconium 2-(N,N-dimethylamino)benzyl;

N,N′-diisopropyl-3-t-butyl-1,3-diketimine indium-bis-(cyclopentadienyl) zirconium 1,diphenyl-1,3-butadiene;

N,N′-diisopropyl-3-t-butyl-1,3-diketimine indium-bis-(n-butylcyclopentadienyl)zirconium dichloride;

N,N′-diisopropyl-3-t-butyl-1,3-diketimine indium-bis-(n-butylcyclopentadienyl)zirconium dimethyl;

N,N′-diisopropyl-3-t-butyl-1,3-diketimine indium-bis-(n-butylcyclopentadienyl)zirconium 2-(N,N-dimethylamino)benzyl;

N,N′-diisopropyl-3-t-butyl-1,3-diketimine indium-bis-(n-butylcyclopentadienyl)zirconium 1,diphenyl-1,3-butadiene;

N,N′-diisopropyl-3-t-butyl-1,3-diketimine indium-bis-(inden-1-yl)zirconium dichloride;

N,N′-diisopropyl-3-t-butyl-1,3-diketimine indium-bis-(inden-1-yl)zirconium dimethyl;

N,N′-diisopropyl-3-t-butyl-1,3-diketimine indium-bis-(inden-1-yl)zirconium 2-(N,N-dimethylamino)benzyl;

N,N′-diisopropyl-3-t-butyl-1,3-diketimine indium-bis-(inden-1-yl)zirconium 1,diphenyl-1,3-butadiene;

N,N′-diisopropyl-3-t-butyl-1,3-diketimine indium-bis-(2-methyl-4-phenylinden-1-yl)zirconium dichloride;

N,N′-diisopropyl-3-t-butyl-1,3-diketimine indium-bis-(2-methyl-4-phenylinden-1-yl)zirconium dimethyl;

N,N′-diisopropyl-3-t-butyl-1,3-diketimine indium-bis-(2-methyl-4-phenylinden-1-yl)zirconium 2-(N,N-dimethylamino)benzyl;

N,N′-diisopropyl-3-t-butyl-1,3-diketimine indium-bis-(2-methyl-4-phenylinden 1-yl)zirconium 1,diphenyl-1,3-butadiene;

N,N′-diisopropyl-3-t-butyl-1,3-diketimine indium-bis-(3-(1-pyrrolidinyl)inden-1-yl)zirconium dichloride;

N,N′-diisopropyl-3-t-butyl-1,3-diketimine indium-bis-(3-(1-pyrrolidinyl)inden-1-yl)zirconium dimethyl;

N,N′-diisopropyl-3-t-butyl-1,3-diketimine indium-bis-(3-(1-pyrrolidinyl)inden-1-yl)zirconium 2-(N,N-dimethylamino)benzyl;

N,N′-diisopropyl-3-t-butyl-1,3-diketimine indium-bis-(3-(1-pyrrolidinyl)inden-1-yl)zirconium 1,diphenyl-1,3-butadiene;

N,N′-diisopropyl-3-phenyl-1,3-diketimine indium-bis-(cyclopentadienyl) zirconium dichloride;

N,N′-diisopropyl-3-phenyl-1,3-diketimine indium-bis-(cyclopentadienyl) zirconium dimethyl;

N,N′-diisopropyl-3-phenyl-1,3-diketimine indium-bis-(cyclopentadienyl) zirconium 2-(N,N-dimethylamino)benzyl;

N,N′-diisopropyl-3-phenyl-1,3-diketimine indium-bis-(cyclopentadienyl) zirconium 1,diphenyl-1,3-butadiene;

N,N′-diisopropyl-3-phenyl-1,3-diketimine indium-bis-(n-butylcyclopentadienyl) zirconium dichloride;

N,N′-diisopropyl-3-phenyl-1,3-diketimine indium-bis-(n-butylcyclopentadienyl) zirconium dimethyl;

N,N′-diisopropyl-3-phenyl-1,3-diketimine indium-bis-(n-butylcyclopentadienyl) zirconium 2-(N,N-dimethylamino)benzyl;

N,N′-diisopropyl-3-phenyl-1,3-diketimine indium-bis-(n-butylcyclopentadienyl) zirconium 1,diphenyl-1,3-butadiene;

N,N′-diisopropyl-3-phenyl-1,3-diketimine indium-bis-(inden-1-yl) zirconium dichloride;

N,N′-diisopropyl-3-phenyl-1,3-diketimine indium-bis-(inden-1-yl) zirconium dimethyl;

N,N′-diisopropyl-3-phenyl-1,3-diketimine indium-bis-(inden-1-yl) zirconium 2-(N,N-dimethylamino)benzyl;

N,N′-diisopropyl-3-phenyl-1,3-diketimine indium-bis-(inden-1-yl) zirconium 1,diphenyl-1,3-butadiene;

N,N′-diisopropyl-3-phenyl-1,3-diketimine indium-bis-(2-methyl-4-phenylinden-1-yl) zirconium dichloride;

N,N′-diisopropyl-3-phenyl-1,3-diketimine indium-bis-(2-methyl-4-phenylinden-1-yl) zirconium dimethyl;

N,N′-diisopropyl-3-phenyl-1,3-diketimine indium-bis-(2-methyl-4-phenylinden-1-yl) zirconium 2-(N,N-dimethylamino)benzyl;

N,N′-diisopropyl-3-phenyl-1,3-diketimine indium-bis-(2-methyl-4-phenylinden-1-yl) zirconium 1,diphenyl-1,3-butadiene;

N,N′-diisopropyl-3-phenyl-1,3-diketimine indium-bis-(3-(1-pyrrolidinyl)inden-1-yl) zirconium dichloride;

N,N′-diisopropyl-3-phenyl-1,3-diketimine indium-bis-(3-(1-pyrrolidinyl)inden-1-yl) zirconium dimethyl;

N,N′-diisopropyl-3-phenyl-1,3-diketimine indium-bis-(3-(1-pyrrolidinyl)inden-1-yl) zirconium 2-(N,N-dimethylamino)benzyl;

N,N′-diisopropyl-3-phenyl-1,3-diketimine indium-bis-(3-(1-pyrrolidinyl)inden-1-yl) zirconium 1,diphenyl-1,3-butadiene;

N,N′-diisopropyl-dimethylguanidinate indium-bis-(cyclopentadienyl) zirconium dichloride;

N,N′-diisopropyl-dimethylguanidinate indium-bis-(cyclopentadienyl) zirconium dimethyl;

N,N′-diisopropyl-dimethylguanidinate indium-bis-(cyclopentadienyl) zirconium 2-(N,N-dimethylamino)benzyl;

N,N′-diisopropyl-dimethylguanidinate indium-bis-(cyclopentadienyl) zirconium 1,diphenyl-1,3-butadiene;

N,N′-diisopropyl-dimethylguanidinate indium-bis-(n-butylcyclopentadienyl) zirconium dichloride;

N,N′-diisopropyl-dimethylguanidinate indium-bis-(n-butylcyclopentadienyl) zirconium dimethyl;

N,N′-diisopropyl-dimethylguanidinate indium-bis-(n-butylcyclopentadienyl) zirconium 2-(N,N-dimethylamino)benzyl;

N,N′-diisopropyl-dimethylguanidinate indium-bis-(n-butylcyclopentadienyl) zirconium 1,diphenyl-1,3-butadiene;

N,N′-diisopropyl-dimethylguanidinate indium-bis-(inden-1-yl) zirconium dichloride;

N,N′-diisopropyl-dimethylguanidinate indium-bis-(inden-1-yl) zirconium dimethyl;

N,N′-diisopropyl-dimethylguanidinate indium-bis-(inden-1-yl) zirconium 2-(N,N-dimethylamino)benzyl;

N,N′-diisopropyl-dimethylguanidinate indium-bis-(inden-1-yl) zirconium 1,diphenyl-1,3-butadiene;

N,N′-diisopropyl-dimethylguanidinate indium-bis-(2-methyl-4-phenylinden-1-yl) zirconium dichloride;

N,N′-diisopropyl-dimethylguanidinate indium-bis-(2-methyl-4-phenylinden-1-yl) zirconium dimethyl;

N,N′-diisopropyl-dimethylguanidinate indium-bis-(2-methyl-4-phenylinden-1-yl) zirconium 2-(N,N-dimethylamino)benzyl;

N,N′-diisopropyl-dimethylguanidinate indium-bis-(2-methyl-4-phenylinden-1-yl) zirconium 1,diphenyl-1,3-butadiene;

N,N′-diisopropyl-dimethylguanidinate indium-bis-(3-(1-pyrrolidinyl)inden-1-yl) zirconium dichloride;

N,N′-diisopropyl-dimethylguanidinate indium-bis-(3-(1-pyrrolidinyl)inden-1-yl) zirconium dimethyl;

N,N′-diisopropyl-dimethylguanidinate indium-bis-(3-(1-pyrrolidinyl)inden-1-yl) zirconium 2-(N,N-dimethylamino)benzyl;

N,N′-diisopropyl-dimethylguanidinate indium-bis-(3-(1-pyrrolidinyl)inden-1-yl) zirconium 1,diphenyl-1,3-butadiene;

1,3,4,6,7,8-hexahydro-pyrimido[1,2-a] pyrimidinate indium-bis-(cyclopentadienyl)zirconium dichloride;

1,3,4,6,7,8-hexahydro-pyrimido[1,2-a] pyrimidinate indium-bis-(cyclopentadienyl)zirconium dimethyl;

1,3,4,6,7,8-hexahydro-pyrimido[1,2-a] pyrimidinate indium-bis-(cyclopentadienyl)zirconium 2-(N,N-dimethylamino)benzyl;

1,3,4,6,7,8-hexahydro-pyrimido[1,2-a] pyrimidinate indium-bis-(cyclopentadienyl)zirconium 1,diphenyl-1,3-butadiene;

1,3,4,6,7,8-hexahydro-pyrimido[1,2-a] pyrimidinate indium-bis-(n-butylcyclopentadienyl) zirconium dichloride;

1,3,4,6,7,8-hexahydro-pyrimido[1,2-a] pyrimidinate indium-bis-(n-butylcyclopentadienyl) zirconium dimethyl;

1,3,4,6,7,8-hexahydro-pyrimido[1,2-a] pyrimidinate indium-bis-(n-butylcyclopentadienyl) zirconium 2-(N,N-dimethylamino)benzyl;

1,3,4,6,7,8-hexahydro-pyrimido[1,2-a] pyrimidinate indium-bis-(n-butylcyclopentadienyl) zirconium 1,diphenyl-1,3-butadiene;

1,3,4,6,7,8-hexahydro-pyrimido[1,2-a] pyrimidinate indium-bis-(inden-1-yl) zirconium dichloride;

1,3,4,6,7,8-hexahydro-pyrimido[1,2-a] pyrimidinate indium-bis-(inden-1-yl) zirconium dimethyl;

1,3,4,6,7,8-hexahydro-pyrimido[1,2-a] pyrimidinate indium-bis-(inden-1-yl) zirconium 2-(N,N-dimethylamino)benzyl;

1,3,4,6,7,8-hexahydro-pyrimido[1,2-a] pyrimidinate indium-bis-(inden-1-yl) zirconium 1,diphenyl-1,3-butadiene;

1,3,4,6,7,8-hexahydro-pyrimido[1,2-a] pyrimidinate indium-bis-(2-methyl-4-phenylinden-1-yl) zirconium dichloride;

1,3,4,6,7,8-hexahydro-pyrimido[1,2-a] pyrimidinate indium-bis-(2-methyl-4-phenylinden-1-yl) zirconium dimethyl;

1,3,4,6,7,8-hexahydro-pyrimido[1,2-a] pyrimidinate indium-bis-(2-methyl-4-phenylinden-1-yl) zirconium 2-(N,N-dimethylamino)benzyl;

1,3,4,6,7,8-hexahydro-pyrimido [1,2-a] pyrimidinate indium-bis-(2-methyl-4-phenylinden-1-yl) zirconium 1,diphenyl-1,3-butadiene;

1,3,4,6,7,8-hexahydro-pyrimido [1,2-al pyrimidinate indium-bis-(3-(1-pyrrolidinyl)inden-1-yl) zirconium dichloride;

1,3,4,6,7,8-hexahydro-pyrimido[1,2-a] pyrimidinate indium-bis-(3-(1-pyrrolidinyl)inden-1-yl) zirconium dimethyl;

1,3,4,6,7,8-hexahydro-pyrimido[1,2-a] pyrimidinate indium-bis-(3-(1-pyrrolidinyl)inden-1-yl) zirconium 2-(N,N-dimethylamino)benzyl; and

1,3,4,6,7,8-hexahydro-pyrimido[1,2-a] pyrimidinate indium-bis-(3-(1-pyrrolidinyl)inden-1-yl) zirconium 1,diphenyl-1,3-butadiene;

The skilled artisan will recognize that additional members of the foregoing list, obtainable by substitution of known ligands or different Group 4 metals for those specifically named are also included within the invention. Moreover, it should also be recognized that all possible electronic distributions within the molecule, such as η³, η⁴ or η⁵ are intended to be included by the foregoing named compounds.

In general the complexes of the current invention can be prepared by first converting the ligands represented in formula 1a to a dianionic salt (where R⁴ is H) via reaction with a metal amide such as sodium bis(trimethylsilyl)amide or lithium bis(trimethylsilyl)amide. The dianionic ligand derivative is then reacted with a metal complex precursor such as MY³₄, MY³₃, or MY³₂ (and the corresponding Lewis base adducts), where Y³ is defined as above. Alternatively, reactions employing the neutral ligand, where R⁴ is hydrogen, in combination with the metal precursors M(NR³₂)₄ or MR³₄ can be employed. (Preparation of the ligands of formula 2a where Y^{1′} and Y^{2′} are each an NR¹ group can be readily accomplished by contacting a dimetal tetrahydrocarbyloxide compound of the formula ((R⁷O)₂Z)₂, where R⁷ is C₁₋₁₀ hydrocarbyl, or two R⁷ groups together are C₂₋₂₀ dihydrocarbyl, especially bis(catecholato)digallium with an alkali metal C₁₋₄ dihydrocarbylamide, especially lithium dimethylamide.) All of the foregoing reactions are conducted in an inert solvent such as a hydrocarbon solvent or an etheral solvent in the temperature range of −100° C. to 150° C.

An especially useful metal complex precursor reagent corresponds to the formula 3:

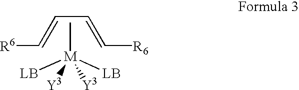

wherein M is zirconium, R⁶ and LB are as previously defined and Y³ each occurrence is chloride. Employment of this precursor in the reaction with ligands of this invention renders the resulting metal complex in high racemic purity, which is especially useful in the stereospecific polymerization of α-olefins.

Alternatively, where R⁴ in structures of formula 1a and 2a is a trimethylsilyl group the ligand can be reacted directly with any of the above metal complex precursors of formula 3, employing similar reaction conditions.

The recovery of the desired Group 4 transition metal complex is accomplished by separation of the product from any alkali metal or alkaline earth metal salts and devolatilization of the reaction medium. Extraction into a secondary solvent may be employed if desired. Alternatively, if the desired product is an insoluble precipitate, filtration or other separation techniques may be employed. Final purification, if required, may be accomplished by recrystallization from an inert solvent, employing low temperatures if needed.

The complexes are rendered catalytically active by combination with an activating cocatalyst or use of an activating technique, such as those that are previously known in the art for use with Group 4 metal olefin polymerization complexes. Suitable activating cocatalysts for use herein include polymeric or oligomeric alumoxanes, especially methylalumoxane, triisobutyl aluminum modified methylalumoxane, or isobutylalumoxane; neutral Lewis acids, such as C₁₋₃₀ hydrocarbyl substituted Group 13 compounds, especially tri(hydrocarbyl)aluminum- or tri(hydrocarbyl)boron compounds and halogenated (including perhalogenated) derivatives thereof, having from 1 to 10 carbons in each hydrocarbyl or halogenated hydrocarbyl group, more especially perfluorinated tri(aryl)boron compounds, and most especially tris(pentafluoro-phenyl)borane; nonpolymeric, compatible, noncoordinating, ion forming compounds (including the use of such compounds under oxidizing conditions), especially the use of ammonium-, phosphonium-, oxonium-, carbonium-, silylium- or sulfonium-salts of compatible, noncoordinating anions, or ferrocenium salts of compatible, noncoordinating anions; bulk electrolysis (explained in more detail hereinafter); and combinations of the foregoing activating cocatalysts and techniques. The foregoing activating cocatalysts and activating techniques have been previously taught with respect to different metal complexes in the following references: EP-A-277,003, U.S. Pat. Nos. 5,153,157, 5,064,802, 5,321,106, 5,721,185, 5,350,723, 5,425,872, 5,625,087, 5,883,204, 5,919,983, 5,783,512, WO 99/15534, and U.S. Ser. No. 09/251,664, filed Feb. 17, 1999.

Combinations of neutral Lewis acids, especially the combination of a trialkylaluminum compound having from 1 to 4 carbons in each alkyl group and a halogenated tri(hydrocarbyl)boron compound having from 1 to 20 carbons in each hydrocarbyl group, especially tris(pentafluorophenyl)borane, further combinations of such neutral Lewis acid mixtures with a polymeric or oligomeric alumoxane, and combinations of a single neutral Lewis acid, especially tris(pentafluorophenyl)borane with a polymeric or oligomeric alumoxane are especially desirable activating cocatalysts. Preferred molar ratios of Group 4 metal complex:tris(pentafluoro-phenylborane:alumoxane are from 1:1:1 to 1:10:30, more preferably from 1:1:1.5 to 1:5:10.

Suitable ion forming compounds useful as cocatalysts in one embodiment of the present invention comprise a cation which is a Bronsted acid capable of donating a proton, and a compatible, noncoordinating anion, A⁻. As used herein, the term “noncoordinating” means an anion or substance which either does not coordinate to the Group 4 metal containing precursor complex and the catalytic derivative derived therefrom, or which is only weakly coordinated to such complexes thereby remaining sufficiently labile to be displaced by a neutral Lewis base. A noncoordinating anion specifically refers to an anion which when functioning as a charge balancing anion in a cationic metal complex does not transfer an anionic substituent or fragment thereof to said cation thereby forming neutral complexes. “Compatible anions” are anions which are not degraded to neutrality when the initially formed complex decomposes and are noninterfering with desired subsequent polymerization or other uses of the complex.

Preferred anions are those containing a single coordination complex comprising a charge-bearing metal or metalloid core which anion is capable of balancing the charge of the active catalyst species (the metal cation) which may be formed when the two components are combined. Also, said anion should be sufficiently labile to be displaced by olefinic, diolefinic and acetylenically unsaturated compounds or other neutral Lewis bases such as ethers or nitriles. Suitable metals include, but are not limited to, aluminum, gallium, niobium or tantalum. Suitable metalloids include, but are not limited to, boron, phosphorus, and silicon. Compounds containing anions which comprise coordination complexes containing a single metal or metalloid atom are, of course, well known and many, particularly such compounds containing a single boron atom in the anion portion, are available commercially.

Preferably such cocatalysts may be represented by the following general formula:

(L*-H)_{d}⁺(A)^{d-}

wherein:

L* is a neutral Lewis base;

(L*-H)⁺ is a conjugate Bronsted acid of L*;

A^{d-} is a noncoordinating, compatible anion having a charge of d−, and

d is an integer from 1 to 3.

More preferably A^{d-} corresponds to the formula: [M′Q₄]⁻;

wherein:

M′ is boron or aluminum in the +3 formal oxidation state; and

Q independently each occurrence is selected from hydride, dialkylamido, halide, hydrocarbyl, hydrocarbyloxide, halo-substituted hydrocarbyl, halo-substituted hydrocarbyloxy, and halo-substituted silylhydrocarbyl radicals (including perhalogenated hydrocarbyl-perhalogenated hydrocarbyloxy- and perhalogenated silylhydrocarbyl radicals), said Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, that is, the counter ion has a single negative charge and is A⁻. Activating cocatalysts comprising boron which are particularly useful in the preparation of catalysts of this invention may be represented by the following general formula:

(L*-H)⁺(BQ₄)⁻;

wherein:

L* is as previously defined;

B is boron in a formal oxidation state of 3; and

Q is a hydrocarbyl-, hydrocarbyloxy-, fluorohydrocarbyl-, fluorohydrocarbyloxy-, hydroxyfluorohydrocarbyl-, dihydrocarbylaluminumoxyfluorohydrocarbyl-, or fluorinated silylhydrocarbyl-group of up to 20 nonhydrogen atoms, with the proviso that in not more than one occasion is Q hydrocarbyl. Most preferably, Q is each occurrence a fluorinated aryl group, especially, a pentafluorophenyl group.

Preferred Lewis base salts are ammonium salts, more preferably trialkylammonium salts containing one or more C₁₂₋₄₀ alkyl groups.

Illustrative, but not limiting, examples of boron compounds which may be used as an activating cocatalyst in the preparation of the improved catalysts of this invention are

tri-substituted ammonium salts such as:

trimethylammonium tetrakis(pentafluorophenyl) borate,

triethylammonium tetrakis(pentafluorophenyl) borate,

tripropylammonium tetrakis(pentafluorophenyl) borate,

tri(n-butyl)ammonium tetrakis(pentafluorophenyl) borate,

tri(sec-butyl)ammonium tetrakis(pentafluorophenyl) borate,

N,N-dimethylanilinium tetrakis(pentafluorophenyl) borate,

N,N-dimethylanilinium n-butyltris(pentafluorophenyl) borate,

N,N-dimethylanilinium benzyltris(pentafluorophenyl) borate,

N,N-dimethylanilinium tetrakis(4-(t-butyldimethylsilyl)-2,3,5,6-tetrafluorophenyl) borate,

N,N-dimethylanilinium tetrakis(4-(triisopropylsilyl)-2,3,5,6-tetrafluorophenyl) borate,

N,N-dimethylanilinium pentafluorophenoxytris(pentafluorophenyl) borate,

N,N-diethylanilinium tetrakis(pentafluorophenyl) borate,

N,N-dimethyl-2,4,6-trimethylanilinium tetrakis(pentafluorophenyl) borate,

dimethyltetradecylammonium tetrakis(pentafluorophenyl) borate,

dimethylhexadecylammonium tetrakis(pentafluorophenyl) borate,

dimethyloctadecylammonium tetrakis(pentafluorophenyl) borate,

methylditetradecylammonium tetrakis(pentafluorophenyl) borate,

methylditetradecylammonium (hydroxyphenyl)tris(pentafluorophenyl) borate,

methylditetradecylammonium (diethylaluminoxyphenyl)tris(pentafluorophenyl) borate,

methyldihexadecylammonium tetrakis(pentafluorophenyl) borate,

methyldihexadecylammonium (hydroxyphenyl)tris(pentafluorophenyl) borate,

methyldihexadecylammonium (diethylaluminoxyphenyl)tris(pentafluorophenyl) borate,

methyldioctadecylammonium tetrakis(pentafluorophenyl) borate,

methyldioctadecylammonium (hydroxyphenyl)tris(pentafluorophenyl) borate,

methyldioctadecylammonium (diethylaluminoxyphenyl)tris(pentafluorophenyl) borate, mixtures of the foregoing,

dialkyl ammonium salts such as:

di-(i-propyl)ammonium tetrakis(pentafluorophenyl) borate,

methyloctadecylammonium tetrakis(pentafluorophenyl) borate,

methyloctadodecylammonium tetrakis(pentafluorophenyl) borate, and

dioctadecylammonium tetrakis(pentafluorophenyl) borate;

tri-substituted phosphonium salts such as:

triphenylphosphonium tetrakis(pentafluorophenyl) borate,

methyldioctadecylphosphonium tetrakis(pentafluorophenyl) borate, and

tri(2,6-dimethylphenyl)phosphonium tetrakis(pentafluorophenyl) borate;

di-substituted oxonium salts such as:

diphenyloxonium tetrakis(pentafluorophenyl) borate,

di(o-tolyl)oxonium tetrakis(pentafluorophenyl) borate, and

di(octadecyl)oxonium tetrakis(pentafluorophenyl) borate;

di-substituted sulfonium salts such as:

di(o-tolyl)sulfonium tetrakis(pentafluorophenyl) borate, and

methylcotadecylsulfonium tetrakis(pentafluorophenyl) borate.

Preferred (L*-H)⁺ cations are methyldioctadecylammonium and dimethyloctadecylammonium. The use of the above Bronsted acid salts as activating cocatalysts for addition polymerization catalysts is known in the art, having been disclosed in U.S. Pat. Nos. 5,064,802, 5,919,983, 5,783,512 and elsewhere.

Another suitable ion forming, activating cocatalyst comprises a salt of a cationic oxidizing agent and a noncoordinating, compatible anion represented by the formula:

(Ox^{e+})_{d}(A^{d-})ₑ.

wherein:

Ox^{e+} is a cationic oxidizing agent having a charge of e+;

e is an integer from 1 to 3; and

A^{d-} and d are as previously defined.

Examples of cationic oxidizing agents include: ferrocenium, hydrocarbyl-substituted ferrocenium, Ag^{+,} or Pb⁺². Preferred embodiments of A^{d-} are those anions previously defined with respect to the Bronsted acid containing activating cocatalysts, especially tetrakis(pentafluorophenyl)borate. The use of the above salts as activating cocatalysts for addition polymerization catalysts is known in the art, having been disclosed in U.S. Pat. No. 5,321,106.

Another suitable ion forming, activating cocatalyst comprises a compound which is a salt of a carbenium ion and a noncoordinating, compatible anion represented by the formula:

\mathring{C}⁺+A⁻

wherein:

\mathring{C}⁺ is a C₁₋₂₀ carbenium ion; and

A⁻ is as previously defined. A preferred carbenium ion is the trityl cation, that is triphenylmethylium. The use of the above carbenium salts as activating cocatalysts for addition polymerization catalysts is known in the art, having been disclosed in U.S. Pat. No. 5,350,723.

A further suitable ion forming, activating cocatalyst comprises a compound which is a salt of a silylium ion and a noncoordinating, compatible anion represented by the formula:

R₃Si(X′)_{q}⁺A⁻

wherein:

R is C₁₋₁₀ hydrocarbyl, and X′, q and A⁻ are as previously defined.

Preferred silylium salt activating cocatalysts are trimethylsilylium tetrakispentafluorophenylborate, triethylsilylium tetrakispentafluorophenylborate and ether substituted adducts thereof. The use of the above silylium salts as activating cocatalysts for addition polymerization catalysts is known in the art, having been disclosed in U.S. Pat. No. 5,625,087.

Certain complexes of alcohols, mercaptans, silanols, and oximes with tris(pentafluorophenyl)borane are also effective catalyst activators and may be used according to the present invention. Such cocatalysts are disclosed in U.S. Pat. No. 5,296,433.

Another class of suitable catalyst activators are expanded anionic compounds corresponding to the formula: (A^{1+a}^{¹})_{b}_{²}(Z¹J¹ⱼ_{¹})^{-c1}_{d}_{¹},

wherein:

A¹ is a cation of charge +a¹,

Z¹ is an anion group of from 1 to 50, preferably 1 to 30 atoms, not counting hydrogen atoms, further containing two or more Lewis base sites;

J¹ independently each occurrence is a Lewis acid coordinated to at least one Lewis base site of Z¹, and optionally two or more such J¹ groups may be joined together in a moiety having multiple Lewis acidic functionality,

j¹ is a number from 2 to 12 and

a¹, b¹, c¹, and d¹ are integers from 1 to 3, with the proviso that a¹×b¹ is equal to c¹×d¹.

The foregoing cocatalysts (illustrated by those having imidazolide, substituted imidazolide, imidazolinide, substituted imidazolinide, benzimidazolide, or substituted benzimidazolide anions) may be depicted schematically as follows:

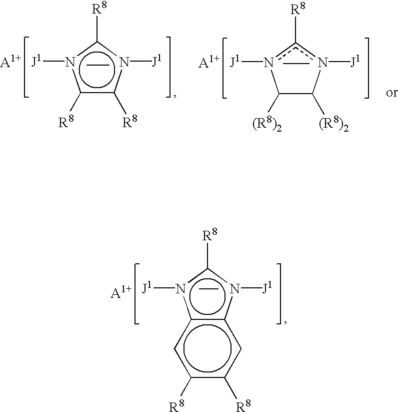

wherein:

A¹⁺ is a monovalent cation as previously defined, and preferably is a trihydrocarbyl ammonium cation, containing one or two C₁₀₋₄₀ alkyl groups, especially the methylbis(tetradecyl)ammonium- or methylbis(octadecyl)ammonium-cation,

R⁸, independently each occurrence, is hydrogen or a halo, hydrocarbyl, halocarbyl, halohydrocarbyl, silylhydrocarbyl, or silyl, (including mono-, di- and tri(hydrocarbyl)silyl) group of up to 30 atoms not counting hydrogen, preferably C₁₋₂₀ alkyl, and

J¹ is tris(pentafluorophenyl)borane or tris(pentafluorophenyl)aluminane.

Examples of these catalyst activators include the trihydrocarbylammonium-, especially, methylbis(tetradecyl)ammonium- or methylbis(octadecyl)ammonium-salts of:

bis(tris(pentafluorophenyl)borane)imidazolide,

bis(tris(pentafluorophenyl)borane)-2-undecylimidazolide, bis(tris(pentafluorophenyl)borane)-

2-heptadecylimidazolide, bis(tris(pentafluorophenyl)borane)-4,5-bis(undecyl)imidazolide,

bis(tris(pentafluorophenyl)borane)-4,5-bis(heptadecyl)imidazolide,

bis(tris(pentafluorophenyl)borane)imidazolinide,

bis(tris(pentafluorophenyl)borane)-2-undecylimidazolinide,

bis(tris(pentafluorophenyl)borane)-2-heptadecylimidazolinide,

bis(tris(pentafluorophenyl)borane)-4,5-bis(undecyl)imidazolinide,

bis(tris(pentafluorophenyl)borane)-4,5-bis(heptadecyl)imidazolinide,

bis(tris(pentafluorophenyl)borane)-5,6-dimethylbenzimidazolide,

bis(tris(pentafluorophenyl)borane)-5,6-bis(undecyl)benzimidazolide,

bis(tris(pentafluorophenyl)alumane)imidazolide,

bis(tris(pentafluorophenyl)alumane)-2-undecylimidazolide,

bis(tris(pentafluorophenyl)alumane)-2-heptadecylimidazolide,

bis(tris(pentafluorophenyl)alumane)-4,5-bis(undecyl)imidazolide,

bis(tris(pentafluorophenyl)alumane)-4,5-bis(heptadecyl)imidazolide,

bis(tris(pentafluorophenyl)alumane)imidazolinide,

bis(tris(pentafluorophenyl)alumane)-2-undecylimidazolinide,

bis(tris(pentafluorophenyl)alumane)-2-heptadecylimidazolinide,

bis(tris(pentafluorophenyl)alumane)-4,5-bis(undecyl)imidazolinide,

bis(tris(pentafluorophenyl)alumane)-4,5-bis(heptadecyl)imidazolinide,

bis(tris(pentafluorophenyl)alumane)-5,6-dimethylbenzimidazolide, and

bis(tris(pentafluorophenyl)alumane)-5,6-bis(undecyl)benzimidazolide.

A further class of suitable activating cocatalysts include cationic Group 13 salts corresponding to the formula:

[M″Q¹₂L′_{1′}]⁺(Ar^{f}₃M′Q²)⁻

wherein:

M″ is aluminum, gallium, or indium;

M′ is boron or aluminum;

Q¹ is C₁₋₂₀ hydrocarbyl, optionally substituted with one or more groups which independently each occurrence are hydrocarbyloxy, hydrocarbylsiloxy, hydrocarbylsilylamino, di(hydrocarbylsilyl)amino, hydrocarbylamino, di(hydrocarbyl)amino, di(hydrocarbyl)phosphino, or hydrocarbylsulfido groups having from 1 to 20 atoms other than hydrogen, or, optionally, two or more Q¹ groups may be covalently linked with each other to form one or more fused rings or ring systems;

Q² is an alkyl group, optionally substituted with one or more cycloalkyl or aryl groups, said Q² having from 1 to 30 carbons;

L′ is a monodentate or polydentate Lewis base, preferably L′ is reversibly coordinated to the metal complex such that it may be displaced by an olefin monomer, more preferably L′ is a monodentate Lewis base;

1′ is a number greater than zero indicating the number of Lewis base moieties, L′, and

Ar^{f} independently each occurrence is an anionic ligand group; preferably Ar^{f} is selected from the group consisting of halide, C₁₋₂₀ halohydrocarbyl, and Q¹ ligand groups, more preferably Ar^{f} is a fluorinated hydrocarbyl moiety of from 1 to 30 carbon atoms, most preferably Ar^{f} is a fluorinated aromatic hydrocarbyl moiety of from 6 to 30 carbon atoms, and most highly preferably Ar^{f} is a perfluorinated aromatic hydrocarbyl moiety of from 6 to 30 carbon atoms.

Examples of the foregoing Group 13 metal salts are alumicinium tris(fluoroaryl)borates or gallicinium tris(fluoroaryl)borates corresponding to the formula:

[M″Q¹₂L′_{1′}]⁺(Ar^{f}₃BQ²)⁻,

wherein M″ is aluminum or gallium; Q¹ is C₁₋₂₀ hydrocarbyl, preferably C₁₋₈ alkyl; Ar^{f} is perfluoroaryl, preferably pentafluorophenyl; and Q² is C₁₋₈ alkyl, preferably C₁₋₈ alkyl. More preferably, Q¹ and Q² are identical C₁₋₈ alkyl groups, most preferably, methyl, ethyl or octyl.

The foregoing activating cocatalysts may also be used in combination. An especially preferred combination is a mixture of a tri(hydrocarbyl)aluminum or tri(hydrocarbyl)borane compound having from 1 to 4 carbons in each hydrocarbyl group or an ammonium borate with an oligomeric or polymeric alumoxane compound.

The molar ratio of catalyst/cocatalyst employed preferably ranges from 1:10,000 to 100:1, more preferably from 1:5000 to 10:1, most preferably from 1:1000 to 1:1. Alumoxane, when used by itself as an activating cocatalyst, is employed in large quantity, generally at least 100 times the quantity of metal complex on a molar basis. Tris(pentafluorophenyl)borane, where used as an activating cocatalyst is employed in a molar ratio to the metal complex of form 0.5:1 to 10:1, more preferably from 1:1 to 6:1 most preferably from 1:1 to 5:1. The remaining activating cocatalysts are generally employed in approximately equimolar quantity with the metal complex.

The catalysts, whether or not supported in any suitable manner, may be used to polymerize ethylenically unsaturated monomers having from 2 to 100,000 carbon atoms either alone or in combination. Preferred addition polymerizable monomers for use herein include olefins, diolefins and mixtures thereof. Preferred olefins are aliphatic or aromatic compounds containing vinylic unsaturation as well as cyclic compounds containing ethylenic unsaturation. Examples of the latter include cyclobutene, cyclopentene, norbornene, and norbornene derivatives that are substituted in the 5- and 6-positions with C₁₋₂₀ hydrocarbyl groups. Preferred diolefins are C₄₋₄₀ diolefin compounds, including ethylidene norbornene, 1,4-hexadiene, norbornadiene, and the like. The catalysts and processes herein are especially suited for use in preparation of ethylene/1-butene, ethylene/1-hexene, ethylene/styrene, ethylene/propylene, ethylene/1-pentene, ethylene/4-methyl-1-pentene and ethylene/1-octene copolymers as well as terpolymers of ethylene, propylene and a nonconjugated diene, such as, for example, EPDM terpolymers.

Most preferred monomers include the C₂₋₂₀ α-olefins, especially ethylene, propylene, isobutylene, 1-butene, 1-pentene, 1-hexene, 3-methyl-1-pentene, 4-methyl-1-pentene, 1-octene, 1-decene, long chain macromolecular α-olefins, and mixtures thereof. Other preferred monomers include styrene, C₁₋₄ alkyl substituted styrene, ethylidenenorbornene, 1,4-hexadiene, 1,7-octadiene, vinylcyclohexane, 4-vinylcyclohexene, divinylbenzene, and mixtures thereof with ethylene. Long chain macromolecular α-olefins are vinyl terminated polymeric remnants formed in situ during continuous solution polymerization reactions. Under suitable processing conditions such long chain macromolecular units are readily polymerized into the polymer product along with ethylene and other short chain olefin monomers to give small quantities of long chain branching in the resulting polymer.

Preferred monomers include a combination of ethylene and one or more comonomers selected from monovinyl aromatic monomers, 4-vinylcyclohexene, vinylcyclohexane, norbornadiene, ethylidene-norbornene, C₃₋₁₀ aliphatic α-olefins (especially propylene, isobutylene, 1-butene, 1-hexene, 3-methyl-1-pentene, 4-methyl-1-pentene, and 1-octene), and C₄₋₄₀ dienes. Most preferred monomers are mixtures of ethylene and styrene; mixtures of ethylene, propylene and styrene; mixtures of ethylene, styrene and a nonconjugated diene, especially ethylidenenorbornene or 1,4-hexadiene, and mixtures of ethylene, propylene and a nonconjugated diene, especially ethylidenenorbornene or 1,4-hexadiene.

In general, the polymerization may be accomplished at conditions well known in the prior art for Ziegler-Natta or Kaminsky-Sinn type polymerization reactions, that is, temperatures from 0-250° C., preferably 30 to 200° C. and pressures from atmospheric to 10,000 atmospheres. Suspension, solution, slurry, gas phase, solid state powder polymerization or other process condition may be employed if desired. A support, especially silica, alumina, or a polymer (especially poly(tetrafluoroethylene) or a polyolefin) may be employed, and desirably is employed when the catalysts are used in a gas phase polymerization process. The support is preferably employed in an amount to provide a weight ratio of catalyst (based on metal):support from 1:10⁶ to 1:10³, more preferably from 1:10⁶to 1:10⁴.

In most polymerization reactions the molar ratio of catalyst:polymerizable compounds employed is from 10⁻¹²:1 to 10^{31 1}:1, more preferably from 10⁻⁹:1 to 10⁻⁵:1.

Suitable solvents use for solution polymerization are liquids that are substantially inert under process conditions encountered in their usage. Examples include straight and branched-chain hydrocarbons such as isobutane, butane, pentane, hexane, heptane, octane, and mixtures thereof; cyclic and alicyclic hydrocarbons such as cyclohexane, cycloheptane, methylcyclohexane, methylcycloheptane, and mixtures thereof; perfluorinated hydrocarbons such as perfluorinated C₄₋₁₀ alkanes, and alkyl-substituted aromatic compounds such as benzene, toluene, xylene, and ethylbenzene. Suitable solvents also include liquid olefins which may act as monomers or comonomers.

The catalysts may be utilized in combination with at least one additional homogeneous or heterogeneous polymerization catalyst in the same reactor or in separate reactors connected in series or in parallel to prepare polymer blends having desirable properties. An example of such a process is disclosed in WO 94/00500.

The catalysts of the present invention are particularly advantageous for the production of ethylene homopolymers and ethylene/α-olefin copolymers having high levels of long chain branching. The use of the catalysts of the present invention in continuous polymerization processes, especially continuous, solution polymerization processes, allows for elevated reactor temperatures which favor the formation of vinyl terminated polymer chains that may be incorporated into a growing polymer, thereby giving a long chain branch. The use of the present catalyst compositions advantageously allows for the economical production of ethylene/α-olefin copolymers having processability similar to high pressure, free radical produced low density polyethylene.

The present catalyst compositions may be advantageously employed to prepare olefin polymers having improved processing properties by polymerizing ethylene alone or ethylene/α-olefin mixtures with low levels of a “H” branch inducing diene, such as norbornadiene, 1,7-octadiene, or 1,9-decadiene. The unique combination of elevated reactor temperatures, high molecular weight (or low melt indices) at high reactor temperatures and high comonomer reactivity advantageously allows for the economical production of polymers having excellent physical properties and processability. Preferably such polymers comprise ethylene, a C₃₋₂₀ α-olefin and a “H”-branching comonomer. Preferably, such polymers are produced in a solution process, most preferably a continuous solution process.

The catalyst composition may be prepared as a homogeneous catalyst by addition of the requisite components to a solvent or diluent in which polymerization will be conducted. The catalyst composition may also be prepared and employed as a heterogeneous catalyst by adsorbing, depositing or chemically attaching the requisite components on an inorganic or organic particulated solid. Examples of such solids include, silica, silica gel, alumina, clays, expanded clays (aerogels), aluminosilicates, trialkylaluminum compounds, and organic or inorganic polymeric materials, especially polyolefins. In a preferred embodiment, a heterogeneous catalyst is prepared by reacting an inorganic compound, preferably a tri(C₁₋₄ alkyl)aluminum compound, with an activating cocatalyst, especially an ammonium salt of a hydroxyaryl(trispentafluoro-phenyl)borate, such as an ammonium salt of (4-hydroxy-3,5-ditertiarybutylphenyl)tris-(pentafluorophenyl)borate or (4-hydroxyphenyl)-tris(pentafluorophenyl)borate. This activating cocatalyst is deposited onto the support by coprecipitating, imbibing, spraying, or similar technique, and thereafter removing any solvent or diluent. The metal complex is added to the support, also by adsorbing, depositing or chemically attaching the same to the support, either subsequently, simultaneously or prior to addition of the activating cocatalyst.

When prepared in heterogeneous or supported form, the catalyst composition is employed in a slurry or gas phase polymerization. As a practical limitation, slurry polymerization takes place in liquid diluents in which the polymer product is substantially insoluble. Preferably, the diluent for slurry polymerization is one or more hydrocarbons with less than 5 carbon atoms. If desired, saturated hydrocarbons such as ethane, propane or butane may be used in whole or part as the diluent. Likewise, the a-olefin monomer or a mixture of different α-olefin monomers may be used in whole or part as the diluent. Most preferably, at least a major part of the diluent comprises the α-olefin monomer or monomers to be polymerized. A dispersant, particularly an elastomer, may be dissolved in the diluent utilizing techniques known in the art, if desired.

At all times, the individual ingredients as well as the recovered catalyst components must be protected from oxygen and moisture. Therefore, the catalyst components and catalysts must be prepared and recovered in an oxygen and moisture free atmosphere. Preferably, therefore, the reactions are performed in the presence of an dry, inert gas, such as, for example, nitrogen.

The polymerization may be carried out as a batchwise or a continuous polymerization process. A continuous process is preferred, in which event catalyst, ethylene, comonomer, and optionally solvent, are continuously supplied to the reaction zone, and polymer product continuously removed therefrom.

Without limiting in any way the scope of the invention, one means for carrying out such a polymerization process is as follows: In a stirred-tank reactor, the monomers to be polymerized are introduced continuously, together with solvent and an optional chain transfer agent. The reactor contains a liquid phase composed substantially of monomers, together with any solvent or additional diluent and dissolved polymer. If desired, a small amount of a “H”-branch inducing diene such as norbornadiene, 1,7-octadiene or 1,9-decadiene may also be added. Catalyst and cocatalyst are continuously introduced in the reactor liquid phase. The reactor temperature and pressure may be controlled by adjusting the solvent/monomer ratio, the catalyst addition rate, as well as by cooling or heating coils, jackets or both. The polymerization rate is controlled by the rate of catalyst addition. The ethylene content of the polymer product is determined by the ratio of ethylene to comonomer in the reactor, which is controlled by manipulating the respective feed rates of these components to the reactor. The polymer product molecular weight is controlled, optionally, by controlling other polymerization variables such as the temperature, monomer concentration, or by the previously mention chain transfer agent, such as a stream of hydrogen introduced to the reactor, as is well known in the art. The reactor effluent is contacted with a catalyst kill agent such as water. The polymer solution is optionally heated, and the polymer product is recovered by flashing off gaseous monomers as well as residual solvent or diluent at reduced pressure, and, if necessary, conducting further devolatilization in equipment such as a devolatilizing extruder. In a continuous process the mean residence time of the catalyst and polymer in the reactor generally is from about 5 minutes to 8 hours, and preferably from 10 minutes to 6 hours.

Ethylene homopolymers and ethylene/α-olefin copolymers are particularly suited for preparation according to the invention. Generally such polymers have densities from 0.85 to 0.96 g/ml. Typically the molar ratio of α-olefin comonomer to ethylene used in the polymerization may be varied in order to adjust the density of the resulting polymer. When producing materials with a density range of from 0.91 to 0.93 the comonomer to monomer ratio is less than 0.2, preferably less than 0.05, even more preferably less than 0.02, and may even be less than 0.01. In the above polymerization process hydrogen has been found to effectively control the molecular weight of the resulting polymer. Typically, the molar ratio of hydrogen to monomer is less than about 0.5, preferably less than 0.2, more preferably less than 0.05, even more preferably less than 0.02 and may even be less than 0.01.

### EXAMPLES

It is understood that the present invention is operable in the absence of any component which has not been specifically disclosed. The following examples are provided in order to further illustrate the invention and are not to be construed as limiting. Unless stated to the contrary, all parts and percentages are expressed on a weight basis. The term “overnight”, if used, refers to a time of approximately 16-18 hours, “room temperature”, if used, refers to a temperature of about 20-25° C., and “mixed alkanes” refers to a mixture of hydrogenated propylene oligomers, mostly C₆-C₁₂ isoalkanes, available commercially under the trademark Isopar E™ from Exxon Chemicals Inc.

All solvents were purified using the technique disclosed by Pangborn et al, Organometallics, 15, 1518-1520, (1996). All compounds, solutions, and reactions were handled under an inert atmosphere (dry box). The ¹H (300 MHz) and ¹³C{H} NMR (75 MHz) spectra were recorded on Varian Mercury Vx and Inova 300 spectrometers. The ¹H and ¹³C NMR spectra are referenced to the residual solvent peaks and are reported in ppm relative to tetramethylsilane. All J values are given in Hz. Tetrahydrofuran (THF), diethylether, toluene, and hexane were used following passage through double columns charged with activated alumina and Q-5® catalyst. The compounds Ti(NMe₂)₄, 1,3-diisopropylcarbodiimide, t-butyllithium, and 2,6-diisopropylaniline were all used as purchased from Aldrich. The compound B(C₆F₅)₃ was used as purchased from Boulder Scientific. All syntheses were performed under dry nitrogen or argon atmospheres using a combination of glove box and high vacuum techniques. “HRMS”, refers to high resolution mass spectroscopy.

X-ray data were collected at 173 K on a Siemens SMART PLATFORM equipped with a CCD area detector and graphite monochromator utilizing MoKα radiation (λ=0.71073 Å). Cell parameters were refined using 8192 reflections. A hemisphere of data (1381 frames) was collected using the co-scan method (0.3° frame width). The first 50 frames were remeasured at the end of data collection to monitor instrument and crystal stability (maximum correction on I was <1 percent). Absorption corrections by integration were applied based on measured indexed crystal faces.

The structure was solved by the Direct Methods in SHELXTL5™ (available from Bruker-AXS, Madison, Wis., USA) and refined using full-matrix least squares. The non-H atoms were refined with anisotropic thermal parameters and all of the H atoms were calculated in idealized positions and refined riding on their parent atoms. In the final cycle of refinement, 5769 observed reflections with I>2σ(I) were used to refine 335 parameters and the resulting R₁ and wR₂ were 3.20 percent and 8.15 percent, respectively. Refinement was done using F².

### Example 1

### Bis(dimethylamido)bis(2,6-diisopropylanilide)-indium-t-butyl-N,N′-diisopropylamidinate-titanium

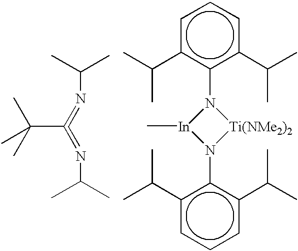

Preparation of t-Butyl-N,N′-diisopropylamidinate, Lithium Salt

1,3-Diisopropylcarbodiimide (7.000 g, 55.47 mmol) was stirred in hexane (50 mL) at 0° C. as excess t-BuLi (1.7 M solution in pentane) was added dropwise. This mixture was allowed to stir overnight at room temperature during which time a white precipitate formed. This mixture was then filtered and the white solid washed with hexane and dried under vacuum and used without further purification or analysis (9.63 g, 91.2 percent yield).

Preparation of Dicloroindium-t-butyl-N,N′-diisopropylamidinate

t-Butyl-N,N′-diisopropylamidinate, lithium salt (9.629 g, 50.61 mmol) and indium trichloride (11.19 g, 50.61 mmol) were mixed together in diethylether (50 mL) at 0° C. and then allowed to stir overnight at room temperature. After the reaction period the volatiles were removed and the residue extracted and filtered using hot toluene. The product was highly insoluable. Following extraction and filtration, the residue was recrystallized from boiling toluene resulting in the isolation of the desired product as a slightly pale yellow crystalline solid (8.990 g, 48.1 percent yield).

¹H NMR (CD₂Cl₂): δ 1.18 (d, ³J_{HH}=6.0 Hz, 12 H), 1.46 (s, 9 H), 4.38 (sept., ³J_{HH}=5.9 Hz, 2H)

¹³C{H} NMR (CD₂Cl₂): δ 26.69, 29.79, 47.75.

HRMS(EI): calculated for C₁₁H₂₃N₂InCl₂ m/z 368.0279, found 368.0280.

Analysis: Calculated. for C₁₁H₂₃N₂InCl₂: C, 35.80; H, 6.28; N, 7.59.

Found: C, 34.49; H, 5.81; N, 7.48

Preparation of 2,6-Diisopropylaniline, Lithium Salt

n-BuLi (56.40 mmol, 35.25 mL of 1.6 M solution in hexane) was added dropwise to a solution of 2,6-diisopropylaniline (10.00 g, 56.40 mmol) in hexane (100 mL). This mixture was allowed to stir for 3 hours during which time a white precipitate formed. After the reaction period the mixture was filtered and the white salt washed with hexane and dried under vacuum and used without further purification or analysis (9.988 g, 96.7 percent yield).

Preparation of Bis(2,6-diisopropylanilide)-indium-t-butyl-N,N′-diisopropylamidinate

2,6-Diisopropylaniline, lithium salt (2.880 g, 15.72 mmol) in diethylether (10 mL) was added dropwise to a slurry of dicloroindium-t-butyl-N,N′-diisopropylamidinate (2.900 g, 7.86 mmol) in diethylether (50 mL) at 0° C. This mixture was then allowed to stir overnight at room temperature. After the reaction period the volatiles were removed under vacuum and the residue extracted and filtered using hexane. Concentration of the filtrate and cooling to −10° C. overnight resulted in the isolation of the desired product as a pale yellow crystalline solid (2.982 g, 58.3 percent yield).

¹H NMR (C₆D₆): δ 0.86 (d, ³J_{HH}=6.0 Hz, 12 H), 1.06 (s, 9 H), 1.28 (d, ³J_{HH}=6.9 Hz, 24 H), 3.24 (sept., ³J_{HH}=6.6 Hz, 4 H), 3.48 (s, 2 H), 3.93 (sept., ³J_{HH}=6.3 Hz, 2 H), 6.90 (t, ³J_{HH}=7.5 Hz, 2H)7.13 (d, ³J_{HH}=2.4 Hz, 4H)

¹³C {H} NMR (C₆D₆): δ23.45, 26.59,28.98,29.80,46.38, 118.83, 123.02,137.46, 148.52

HRMS(EI): calculated for C₃₅H₅₉N₄In m/z 650.3780, found 650.3752

Analysis: Calculated for C₃₄H₅₉N₄In: C, 63.94; H, 9.31; N, 8.77. Found: C, 63.83; H, 9.81; N, 8.64.

Preparation of Bis(dimethylamido)bis(2,6-diisopropylanilide)-indium-t-butyl-N,N′-diisopropylamidinate-titanium

Bis(2,6-diisopropylanilide)-indium-t-butyl-N,N′-diisopropylamidinate (1.000 g, 1.54 mmol) and Ti(NMe₂)₄ were heated together in benzene (20 mL) at 60° C. for eight hours under a nitrogen bubbler. During this time the flask was occaissionally evacuated and then back flushed with fresh nitrogen. The reaction mixture was then placed under full vaccum to remove all volatiles. The mixture was then extracted and filtered using toluene. The toluene solution was then concentrated and placed in a freezer (−10° C.) overnight during which time the desired product precipitated as a yellow crystalline solid (0.394 g, 32.6 percent yield).

¹H NMR (C₆D₆): δ 0.67 (d, ³J_{HH}=6.0 Hz, 12 H), 0.90 (s, 9 H), 1.38 (br, 24 H), 3.24 (s, 12 H), 3.82 (sept., ³J_{HH}=6.2 Hz, 2 H).3.94 (sept., ³J_{HH}=6.9 Hz, 4 H), 6.96 (t, ³J_{HH}=7.6 Hz, 2 H),7.18(d, 3J_{HH}=7.8 Hz, 4H)

¹³C{H} NMR (C₆D₆): 624.6 (br), 25.74,28.38,29.46, 31.92, 39.48,46.56,46.93, 120.09, 123.22, 138.59, 154.38, 174.86

HRMS(EI): calculated for C₃₉H₆₉N₆InTi m/z 784.4103, found 784.4127

Analysis: Calculated for C₃₈H₆₉N₆InTi: C, 59.07; H, 9.00; N, 10.88

Found: C, 60.18; H, 8.57; N, 10.85

Ethylene/Octene (E/O) Copolymerizations

All feeds were passed though columns of activated alumina and Q-5™ catalyst prior to introduction to the reactor. A stirred 2-liter Parr reactor was charged with about 740 g of Isopar-E™ solvent and 118 g of 1-octene comonomer. Hydrogen was added as a molecular weight control agent by differential pressure expansion from a 75 mL addition tank at 25 psi (170 kPa). The reactor contents were then heated to the polymerization temperature of 140° C. and saturated with ethylene at 500 psig (3.4 Mpa). Triisbutylaluminum (TIBA) was added to the reactor in a molar ratio based on metal complex of 50:1. The metal complex (Example 1) and cocatalyst (methylalumoxane (MAO) or triphenylcarbonium tetrakis(pentafluorophenyl)-borate (TCTB)) were mixed as dilute toluene solutions and transferred to a catalyst addition tank and injected into the reactor through a stainless steel transfer line. The polymerization conditions were maintained for 15 minutes with ethylene added on demand. Heat was continually removed from the reaction with an internal cooling coil. The resulting solution was removed from the reactor, quenched with isopropyl alcohol, and stabilized by the addition of 10 mL of a toluene solution containing approximately 67 mg of a hindered phenol antioxidant (Irganox™ 1010 from Ciba Geigy Corporation) and approximately 133 mg of a phosphorous stabilizer (Irgafos™ 168 from Ciba Geigy Corporation). Between polymerization runs a wash cycle was conducted in which 850 g of mixed alkanes were added to the reactor which was then heated to 150° C. and then emptied of the heated solvent immediately prior to a new polymerization run.

Propylene (P) Polymerizations

All feeds were passed though columns of activated alumina and Q-5™ catalyst prior to introduction to the reactor. A stirred 2-liter jacketed Autoclave Engineer's Zipper-Clave™ reactor was charged with about 625 g of Isopar-E solvent and about 150 g of propylene. Hydrogen was added as a molecular weight control agent by differential pressure expansion from a 75 mL addition tank (Δ50 psig, 350 kPa). The reactor was heated to 70° C. and allowed to equilibrate. Triisbutylaluminum (TIBA) was added to the reactor in a molar ratio based on metal complex of 50:1. The metal complex (Example 1) and cocatalyst (methylalumoxane (MAO) were mixed as dilute toluene solutions and transferred to a catalyst addition tank and injected into the reactor through a stainless steel transfer line. Heat was continually removed from the reaction with a cooling coil in the jacket. The resulting mixture was removed from the reactor, quenched with isopropyl alcohol, and stabilized by the addition of 10 mL of a toluene solution containing approximately 67 mg of a hindered phenol antioxidant (Irganox™ 1010 from Ciba Geigy Corporation).

Polymers were recovered by drying for about 20 hours in a vacuum oven set at 140° C. High temperature gel permeation chromatography (GPC) analysis of polymer samples were carried out in 1,2,4-trichlorobenzene at 135° C. on a Waters 150 C high temperature instrument. A polystyrene/polyethylene or polystyrene/polypropylene universal calibration was carried out using narrow molecular weight distribution polystyrene standards. Results are contained in Table 1.

TABLE 1

| | | | Cat./ cocat. | Temp. | Efficiency | |
|---|---|---|---|---|---|---|
| Run | Monomer | Cocatalyst | (μmoles) | (° C.) | (g/mg Ti) | Mw/Mn |
| 1 | E/O | MAO | 1/1000 | 70 | 26 | 167,000/17,500 (9.54) |
| 2 | ″ | ″ | ″ | ″ | 27 | 562,000/56,500 (9.95) |
| 3 | ″ | TPTB | 1/1 | ″ | 34 | 598,000/44,100 (13.56) |
| 4 | ″ | TPTB | ″ | 140 | 7 | 132,000/7,600 (17.4) |
| 5 | ″ | MAO | 1/1000 | ″ | 5 | 144,000/11,200 (12.8) |
| 6 | P | ″ | 1/500 | 70 | 8 | 87,600/12,200 (7.17) |

1. A Group 4 transition metal complex corresponding to the following formula: 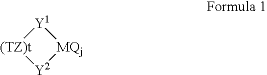
wherein:
M is titanium, zirconium, or hafnium in the +4, +3, or +2 oxidation state;
Y¹ and Y² are independently an anionic or neutral, cyclic or non-cyclic, π-bonded group, NR¹, PR¹; NR¹₂, PR¹, or (R**)₃—P═N—;
R** is in one occurrence a covalent bond to Z and in all remaining occurrences a monovalent ligand selected from hydrogen, halogen, or C₁₋₁₀ hydrocarbyl, or two R** groups together form a divalent ligand,
Z is gallium or indium;
Q is a neutral, anionic or dianionic ligand group depending on the oxidation state of M;
j is 1 or 2 depending on the oxidation state of M and the electronic nature of Q;
t is 1 or 2, and when t is 2 there is a direct Z—Z bond;
T independently each occurrence is: —OR¹, —SR¹, —NR¹₂, —PR¹₂, —N═CR¹₂, —N═PR¹₃, 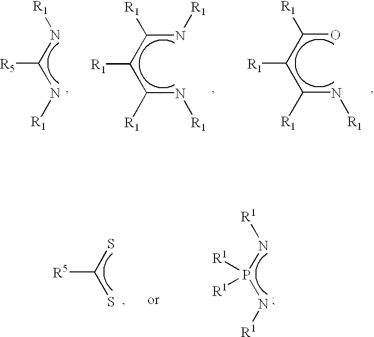
R¹ is independently each occurrence hydrogen, a hydrocarbyl group, a tri(hydrocarbyl)silyl group, or a tri(hydrocarbyl)silylhydrocarbyl group, said R¹ groups containing up to 20 atoms not counting hydrogen;
R⁵ is R¹ or —N(R¹)₂; and
two R¹ groups together or one or more R¹ groups together with R⁵ may optionally be joined to form a ring structure.

2. A metal complex according to claim 1 corresponding to formulas 4, 5, 6 and 7: 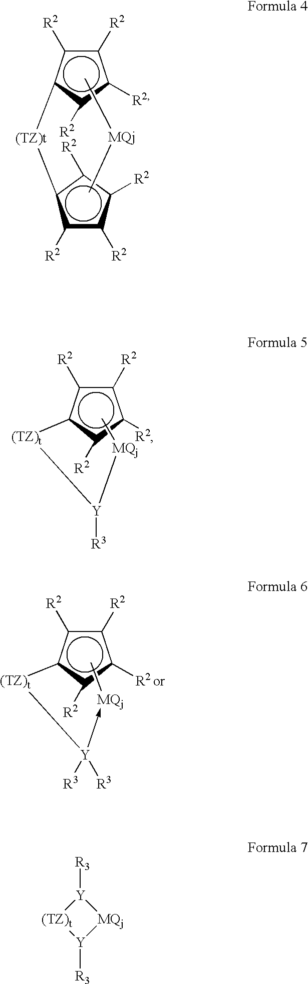
wherein M, Z, T, Q, t and j are as defined in claim 1;
R² is hydrogen, or a hydrocarbyl, halohydrocarbyl, dihydrocarbylamino-hydrocarbyl, tri(hydrocarbylsilyl)hydrocarbyl, Si(R³)₃, N(R³)₂, or OR³ group of up to 20 carbon or silicon atoms, and optionally two adjacent R² groups can be joined together, thereby forming a fused ring structure, especially an indenyl ligand or a substituted indenyl ligand;
R³ is independently hydrogen, a hydrocarbyl group, a trihydrocarbylsilyl group or a trihydrocarbylsilylhydrocarbyl group, said R³ having up to 20 atoms not counting hydrogen; and
Y is nitrogen or phosphorous.

3. A metal complex according to claim 2, formula 4, wherein M is in the +4 oxidation state, j=2 and Q independently each occurrence is halide, hydride, hydrocarbyl, silylhydrocarbyl, hydrocarbyloxide, or dihydrocarbylamide, said Q having up to 20 atoms not counting hydrogen, or two Q groups together form an alkanediyl group or a conjugated C₄₋₄₀ diene ligand that together with M form a metallocyclopentene.

4. A metal complex according to claim 2, formula 5 wherein M is in the +3 oxidation state, j=1 and Q is either 1) a monovalent anionic stabilizing ligand selected from the group consisting of alkyl, cycloalkyl, aryl, silyl, amido, phosphido, alkoxy, aryloxy, sulfido groups, and mixtures thereof, said Q being further substituted with an amine, phosphine, ether, or thioether containing substituent able to form a coordinate-covalent bond or chelating bond with M said ligand having up to 50 atoms not counting hydrogen; or 2) a C₃₋₁₀ hydrocarbyl group comprising an ethylenic unsaturation able to form an η³-bond with M.

5. A metal complex according to claim 2, formula 6 wherein M is in the +3 oxidation state, in formula 6, j=2, Q independently each occurrence is halide, hydride, hydrocarbyl, silylhydrocarbyl, hydrocarbyloxide, dihydrocarbylamide, said Q having up to 20 atoms not counting hydrogen, or two Q groups are joined together to form an alkanediyl group or a conjugated C₄₋₄₀ diene ligand which is coordinated to M in a metallocyclopentene fashion.

6. A metal complex according to claim 2, formula 4 wherein M is in the +2 oxidation state, j=1 and Q is a neutral conjugated diene, optionally substituted with one or more tri(hydrocarbyl)silyl or tri(hydrocarbylsilyl)hydrocarbyl groups, said Q having up to 40 carbon atoms and forming a π-complex with M.

7. A metal complex according to claim 3 wherein M is zirconium, Z is indium, and Q is chloride, methyl or trimethylsilylmethyl.

8. A metal complex according to claim 6 wherein M is zirconium, Z is indium, and Q is 1,4-diphenyl-1,3-butadiene.

9. A metal complex according to claim 8 which is 1,3-diisopropyl-2-t-butyl-amidinato[bis-(2-methyl-4-phenyl-indene)] indium] zirconium (1,4-diphenyl-1,3-butadiene).

10. An olefin polymerization process comprising contacting one or more olefin monomers under polymerization conditions with a catalyst composition comprising a metal complex according to any one of claims 1-9.

11. The process of claim 10 wherein the catalyst composition additionally comprises an activating cocatalyst.

12. The process of claim 11 conducted under solution, slurry or high pressure polymerization conditions.

13. The process of claim 12 conducted under slurry or gas phase polymerization conditions, wherein the catalyst additionally comprises an inert, particulated support.
